(19) United States
(12) Patent Application Publication
(10) Pub. No.: US 2022/0250149 A1
(43) Pub. Date: Aug. 11, 2022

(54) TECHNIQUES FOR CONTROLLING BUILD MATERIAL FLOW CHARACTERISTICS IN ADDITIVE MANUFACTURING AND RELATED SYSTEMS AND METHODS

(71) Applicant: Desktop Metal, Inc., Burlington, MA (US)

(72) Inventors: Michael A. Gibson, Boston, MA (US); Alexander C. Barbati, Melrose, MA (US); George Hudelson, Billerica, MA (US); Robert J. Nick, Pepperell, MA (US); Paul A. Hoisington, Hanover, NH (US); Brian D. Kernan, Andover, MA (US)

(73) Assignee: Desktop Metal, Inc., Burlington, MA (US)

(21) Appl. No.: 17/292,816

(22) PCT Filed: Nov. 8, 2019
(86) PCT No.: PCT/US2019/060499

§ 371 Date: May 11, 2021

Related U.S. Application Data
(60) Provisional application No. 62/759,911, filed on Nov. 12, 2018.
(60) Provisional application No. 62/840,056, filed on Apr. 29, 2019.

(51) Int. Cl. B22F 10/14; B33Y 10/00; B33Y 40/20; B33Y 70/10; B22F 10/60; B22F 3/26; B22F 1/16

(52) U.S. Cl. CPC B22F 10/14; B33Y 10/00; B33Y 40/20; B22F 1/16; B22F 10/60; B22F 3/26; B33Y 70/10

(57) ABSTRACT

Embodiments described herein relate to methods and systems for controlling the packing behavior of powders for additive manufacturing applications. In some embodiments, a method for additive manufacturing includes adding a packing modifier to a base powder to form a build material. The build material may be spread to form a layer across a powder bed, and the build material may be selectively joined along a two-dimensional pattern associated with the layer. The steps of spreading a layer of build material and selectively joining the build material in the layer may be repeated to form a three-dimensional object. The packing modifier may be selected to enhance one or more powder packing and/or powder flow characteristics of the base powder to provide for improved uniformity of the additive manufacturing process, promote sintering, and/or to enhance the properties of the manufactured three-dimensional objects.

### FIELD

Disclosed embodiments generally relate to methods and systems for controlling the packing of powders used in additive manufacturing processes and related applications.

### BACKGROUND

Additive manufacturing processes are widely used to build three-dimensional objects through successive addition of thin layers of material. For example, binder jetting is an additive manufacturing technique based on the use of a binder to join particles of a powder (e.g., a metallic powder) to form a three-dimensional object. In a binder jetting process, one or more liquids (e.g., a binder formulation, components of a binder system, solvents which interact with a binder in the powder, and so on) are jetted from a print head onto successive layers of powder in a powder bed spread across the powder. The layers of the powder and the binder adhere to one another to form a three-dimensional green part, and through subsequent processing the green part can be formed into a final three-dimensional part. Such processing may include debinding, in which the binder liquid(s) are removed from the part; sintering, in which a part is, through the application of heat, compacted and formed into a solid mass without melting to the point of liquefaction; and/or infiltration, in which an additional material is drawn into a part through a porous structure of the part.

### SUMMARY

According to some aspects, a method of fabricating a metal and/or ceramic part through additive manufacturing is provided, the method comprising depositing a layer of a build material over a build surface, wherein the build material comprises a base powder mixed with one or more packing modifiers, wherein the base powder comprises a metallic powder and/or a ceramic powder, and wherein the packing modifier comprises one or more metal oxides, metal carbides, metal silicides, metal nitrides, and/or intermetallic compounds, selectively joining one or more regions of the build material within the deposited layer by depositing a liquid onto the one or more regions, repeating said acts of depositing and selectively joining for a plurality of layers of the build material to form a first part, and forming a metal and/or ceramic part by thermally processing the first part.

According to some aspects, a method of fabricating a metal and/or ceramic part through additive manufacturing is provided, the method comprising depositing a layer of a build material over a build surface, wherein the build material comprises a base powder mixed with one or more packing modifiers, wherein the base powder comprises a metallic powder and/or a ceramic powder, and wherein the packing modifier comprises one or more metal oxides, carbides, silicides, nitrides, hydrides, and/or intermetallic compounds, selectively joining one or more regions of the build material within the deposited layer by depositing a liquid onto the one or more regions, and repeating said acts of depositing and selectively joining for a plurality of layers of the build material to form a first part.

According to some aspects, a method of fabricating a metal and/or ceramic part through additive manufacturing is provided, the method comprising depositing a layer of a build material over a build surface, wherein the build material comprises a base powder mixed with one or more packing modifiers, wherein the base powder comprises a metallic powder and/or a ceramic powder, and wherein the packing modifier comprises one or more metal oxides, carbides, silicides, nitrides, hydrides, and/or intermetallic compounds, selectively joining one or more regions of the build material within the deposited layer, and repeating said acts of depositing and selectively joining for a plurality of layers of the build material to form a first part.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

Non-limiting embodiments will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment shown where illustration is not necessary to allow those of ordinary skill in the art to understand the present disclosure. In the figures:

FIG. 1 is a schematic representation of an additive manufacturing system, according to some embodiments;

FIG. 2 is a schematic representation of an additive manufacturing plant including an additive manufacturing system and a post processing station, according to some embodiments;

FIG. 3 is a flow chart depicting a method for additive manufacturing, according to one embodiment;

FIGS. 4A-4B illustrate interactions between particles of a build materials without and with an included packing modifier, respectively, according to some embodiments;

FIG. 5 is a schematic representation of a portion of a build material, according to some embodiments;

FIG. 6 depicts illustrative materials that may be utilized as a packing modifier, according to some embodiments;

FIG. 7A is a graph showing the effect of a packing modifier on a cohesion of a base powder, according to one example;

FIG. 7B is a graph showing the effect of a packing modifier on a flow function of a base powder, according to one example;

FIG. 7C is a graph showing the effect of a packing modifier on a powder bed volume packing fraction a of a base powder, according to one example;

FIG. 7D is a graph showing the effects of a packing modifier on a tap density and an apparent density of a base powder, according to one example;

FIG. 8 depicts an illustrative process of mixing a packing modifier with a powder to produce a build material, according to some embodiments;

FIGS. 9A-9B depict an illustrative apparatus for mixing a packing modifier with a powder to produce a build material within an additive fabrication device, according to some embodiments;

FIGS. 10A-10C illustrate a first example of mixing a packing modifier with a powder to produce a build material using an air-driven mixing unit, according to some embodiments;

FIG. 11 illustrates an example of a computing system environment on which aspects of the invention may be implemented; and

FIG. 12 is a block diagram of a system suitable for practicing aspects of the invention, according to some embodiments.

### DETAILED DESCRIPTION

The packing of a powder used in a powder-based additive manufacturing process (e.g., a three-dimensional printing process such as a binder jetting process) can have a significant impact on the performance of the process and the quality of manufactured parts. For example, the powder packing behavior can impact the ability of the powder to spread evenly across and through a powder bed, which in turn can affect the homogeneity of a final manufactured part. In particular, cohesion and/or friction between the particles comprising the powder may result from a number of sources, such as electrostatic interactions, capillary effects, physical interlocking of particles in the powder, tacky coatings which may be present on some particles in the powder, and so on.

The inventors have recognized that interparticle forces between adjacent particles that are in contact and/or near contact with one another can cause binding forces of attraction. This effect, as well as others, can lead to cohesion and/or friction that can limit the ability of the particles to flow relative to one another when a layer of powder is spread across and through the powder bed, which can lead to inhomogeneity within the powder layers and/or between the powder layers, and ultimately inhomogeneity in the manufactured parts. Such inhomogeneity may manifest as an inhomogeneity of material properties of a manufactured part (e.g., inhomogeneity of density or hardness), or as an inhomogeneity of a material response during post-processing (e.g., an inhomogeneous or inconsistent shrinkage during a sintering process).

The inventors have further recognized and appreciated numerous advantages associated with methods and systems for additive manufacturing in which a packing modifier is added to a base powder comprising at least one of a metal and a ceramic to control the packing behavior of the build material used in an additive manufacturing process. Conventional approaches for controlling powder packing and/or powder flow may not be suitable for certain additive manufacturing processes, such as those involving metal powders. For example, approaches such as heating, agitating, and/or filtering a metal and/or ceramic base powder may be not be able to adequately enhance the powder packing for additive manufacturing applications, and may be undesirable in that they necessitate additional processing steps. Other conventional approaches used outside of additive manufacturing contexts may be undesirable in some additive manufacturing applications in that they necessitate the introduction of foreign materials into the base powder that can adversely affect various steps of the additive manufacturing process. For example, such materials may inhibit the bonding and/or sintering steps of a binder jetting process, which would reduce the quality of a manufactured part.

Thus, the inventors have recognized and appreciated numerous benefits associated with packing modifiers that can enhance the packing characteristics of a base powder while not interfering with other aspects of an additive manufacturing process. For instance, some classes of packing modifiers recognized by the inventors can be effectively combined with a base powder such that, when the combination of packing modifier and base powder are utilized as a build material in additive fabrication, the packing modifier is easily reduced. For example, certain metal oxides, when mixed with a metallic based powder and a part fabricated from the resulting build material, may be easily reduced to produce a fully metal part (e.g., during thermal processing of the part or otherwise). In some cases, some classes of packing modifiers recognized by the inventors can be effectively combined with a base powder such that, when the combination of packing modifier and base powder are utilized as a build material in additive fabrication, the packing modifier evolves from fabricated parts in a volatile form such that the packing modifier does not substantially integrate with the part. For example, some packing modifiers may evaporate from the part (or may include components that evaporate from the part) during thermal processing.

According to some aspects, the methods and systems described herein include adding a packing modifier to a base powder comprising a metal or ceramic material to form a build material for use in an additive manufacturing process such as a binder jetting process. The packing modifier may enhance the packing behavior of the base powder such that the build material can pack better (e.g., more uniformly and/or more densely) as compared to the base powder alone. This enhanced packing behavior may result in an improved ability to spread the powder across a powder bed, which may improve the quality of the process and manufactured part, as discussed above.

In some embodiments, a packing behavior of a powder may be enhanced by increasing a flowability of the powder, which generally refers to the ability of a powder to flow such that the particles of the powder can move relative to one another. The flowability of a powder may affect how the powder packs as a result of flow and/or rearrangement of the powder particles relative to one another, such as during spreading of a powder layer. Thus the flowability of the powder may impact the packing and/or compaction behavior of the powder, such as how densely and/or uniformly a powder may pack. Thus, according to some aspects, the packing behavior of a powder may be controlled through control of the flowability of the powder. For example, the inventors have recognized and appreciated that in many processes in which flow is occurring (such as the spreading of a powder in a binder jetting process), increasing the flowability of a powder can tend to increase the density and/or uniformity with which the powder packs as a result of that process.

In view of the foregoing, it should be understood that the packing behavior of a powder and the flow characteristics may be related to one another and can influence the ultimate packing density and/or uniformity achieved in a particular process. These flow characteristics and the resulting packing density and/or packing uniformity may be characterized by a variety of metrics, including, but not limited to, a tap density (e.g., as defined in according with ASTM standard B527), an apparent density, a Hausner ratio, a Hall Flow (e.g., as defined in accordance with ASTM standard B213), a Carney flow (e.g., as defined in accordance with ASTM standard B694), a flow function (e.g., as defined in accordance with ASTM standard D6128), a cohesion (e.g., as measured by shear cell testing in accordance with ASTM standards D6128 and/or D7891), a flow energy characterization (e.g., as measured using a suitable powder rheometer), a rate at which a powder compacts (e.g., with respect to a number of taps of a specified amplitude and frequency), a powder bed density, and/or powder bed density uniformity. While several of the above-mentioned metrics are standardized (e.g., according to one or more ASTM standards), it should be understood that other metrics, such as metrics derived from one or more density and/or flow characterization methods representative of a particular process (e.g., a powder bed process such as binder jetting) also may be used to characterize the packing behavior of a powder.

Moreover, the inventors have recognized that changes and/or improvements in one or more of these characteristics may correspondingly change and/or improve the packing density and/or packing uniformity achieved in a process. For example, decreasing the cohesion of a build material (e.g., via the addition of a packing modifier) during a powder blending process step followed by spreading the build material may lead to a higher density of the build material within a build volume and may further result in improved spatial uniformity of the density of the build material within the build volume.

The inventors have further recognized and appreciated that as achievable limits in a packing density are approached (e.g., as measured by sampling several regions of a build volume in a binder-jetting process), higher packing density can often lead to greater packing uniformity. For example, in an ideal powder having a perfectly uniform particle size, packing with the maximum achievable density would also provide for the most uniform packing density. The inventors have appreciated that this correlation is also applicable to non-ideal powders, and achieving the highest possible density can provide for correspondingly higher packing uniformity.

It should be understood that the current disclosure is not limited to any particular characterization of powder packing behavior, and that the above-noted powder characteristics are given by way of non-limiting example. In some instances, other properties associated with powder flow and packing may be usefully affected by the addition of a packing modifier. Moreover, as used herein, a packing modifier may refer to an additive that accomplishes such a modification of flow, packing, and compaction properties of a powder.

In some embodiments, a packing modifier may be selected to provide a build material having a desired change in one or more packing and/or flowability characteristics relative to a base powder. For example, in certain embodiments, addition of a packing modifier can provide for a cohesion of a build material including a base powder and a packing modifier to be between about 0.1 and about 0.8 times a cohesion of the base powder (e.g., about 0.2 to 0.6, about 0.3 to 0.5 times the cohesion of the base powder), though other relative cohesion values may be suitable, such as values less than 0.1. In other embodiments, a measured flow function of a build material may be between about 1.5 and about 5 times a flow function of the base powder (e.g., about 2 times to about 4 times the flow function of the base powder). In further embodiments, addition of a packing modifier to a base powder may result in a build material that exhibits a volume packing density between about 5% and 25% higher than a volume packing density of the base powder (e.g., between about 10% and 20% higher, and/or between about 12% and about 18 percent higher). Moreover, in some embodiments, a build material may exhibit a tap density and/or apparent density between about 5% and about 25% higher than a tap density or apparent density of the base powder. In still further embodiments, a change in a packing or flow characteristic of about 5 to 10 percent may be sufficient to provide a desired response for the build material. It should be understood that the above noted ranges are provided by way of example only, and that other relative changes of a packing and/or flowability characteristic upon the addition of a packing modifier to a base powder may be suitable.

As used herein, a base powder can refer to one or more metallic and/or ceramic powders that can be used in additive manufacturing and/or particulate material processing contexts. Depending on the particular embodiment, a base powder may comprise a pure metal, a metal alloy, an intermetallic compound, one or more compounds containing at least one metallic element, and/or one or more ceramic materials. In some embodiments, the base powder comprises pre-alloyed atomized metallic powders, a water or gas atomized powder, a mixture of a master alloy powder and an elemental powder, a mixture of elemental powders selected to form a desired microstructure upon the interaction of the elemental species (e.g., reaction and/or interdiffusion) during a post-processing step (e.g., sintering), one or more ceramic powders, and/or any other suitable materials. In some instances, the base powder may be a sinterable powder, and/or the base powder may be compatible with an infiltration process. Moreover, the base powder may contain such wetting agents, coatings, and other powder modifications found to be useful in the sintering or infiltration of powdered objects. Accordingly, it should be understood that the current disclosure is not limited to any particular material and/or combination of materials comprising the base powder.

In some embodiments, in a build material including a base powder and a packing modifier in the form of a powder, a particle size of the packing modifier particles may be substantially smaller than the size of the particles comprising a base powder; the size difference between the particles may lead to improved flowability and packing of the build material. As described in more detail below, the smaller packing modifier particles may become interspersed between the particles of the base powder, thereby reducing cohesion between the particles of the base powder. For example, in some embodiments, the base powder may have an average particle size on the order of ones to tens of microns, while the packing modifier powder may have an average particle size ranging from tens or hundreds of nanometers to ones of microns. In cases where Van der Waals forces between adjacent particles that are in contact and/or near contact with one another create binding forces of attraction, the interspersed smaller particles of the packing modifier can act to increase a spacing between the base powder particles. In this manner, the packing modifier may separate the larger base powder particles beyond the spacing at which Van der Waals forces act to aggregate and generally impede any imposed motion of the powder mixture to result in flow and packing after flow has ceased. In at least some cases, references to a “particle size” herein may be understood to refer to a diameter or other characteristic length, rather than to some other measure of size such as volume or mass.

In further embodiments, the packing modifier can be organic and/or polymeric in nature. These further embodiments may include polymeric packing modifier powders having an average particle size ranging from tens or hundreds of nanometers to ones of microns.

According to some aspects, a packing modifier may comprise materials that do not interfere with the various process steps of an additive manufacturing process, and thus the packing modifier powders described herein may allow for improvement in the packing of a base powder while not suffering from the above-noted issues with conventional packing modification approaches. As described below, the packing modifiers described herein may undergo a transformation during one or more steps of the additive manufacturing process (e.g., during thermal processing) such that a concentration of packing modifier in the final part is substantially less than the concentration of packing modifier in the build material. In this manner, the packing modifier can be utilized to control the packing behavior of the build material during portions of the additive manufacturing process where improved packing is beneficial, and subsequently, the packing modifier can be transformed and/or removed so as to not interfere with the properties of the final manufactured part.

In some embodiments, a packing modifier may comprise a metal hydride powder that may undergo a dehydriding reaction to produce a metallic component. Such packing modifiers may be suitable in instances in which the addition of the base metallic component of the metal hydride powder is not undesirable or otherwise deleterious to the additive manufacturing process. For example, in certain embodiments in which the addition of titanium is not undesirable (e.g., the base powder of the build material comprises titanium or a titanium-based alloy), the packing modifier may comprise hydrides of titanium, including but not limited to TiH₂. Such titanium hydrides may undergo dehydriding to produce titanium as a metallic component during one or more processing steps of an additive manufacturing process, such as during a debinding process and/or a sintering process. After dehydriding, the titanium component of the titanium hydride may remain in the part after one or more processing steps and may combine or otherwise become integrated with the metal of the base powder in a subsequent processing step. In this manner, powder particles of the packing modifier and base powder, which may be distinguishable based on a material property or characteristic at the beginning of the additive manufacturing process, may become indistinguishable after one or more processing steps. As such, in some cases it may be preferable for a base powder and a packing modifier to share a common metallic element (e.g., titanium in the above example).

In some embodiments, a packing modifier may comprise boron and/or a boron compound. In some embodiments, a packing modifier may comprise a boride powder that is chemically incorporated with the base powder during at least one step in the additive manufacturing process (e.g., sintering). For instance, a packing modifier may comprise a nickel boride (e.g., NiB, Ni₂B, and the like), an iron boride (e.g., FeB, Fe₂B, and the like), a cobalt boride (e.g., CoB, Co₂B, and the like), a silicon boride (e.g., SiB₃, and the like), a titanium boride (e.g., TiB₂, and the like), a zirconium boride (e.g., ZrB₂, and the like), a tantalum boride (e.g., TaB, TaB₂, and the like), a chromium boride (e.g., CrB₂, and the like), or combinations thereof. In some embodiments, a packing modifier may comprise elemental boron and/or boron oxide. For example, the packing modifier may comprise particles of boron, may comprise particles of one or more boron oxides (B₂O₃, B₆O, for example), and/or may comprise one or more boron oxides with hydrogen (H₃BO₃, also known as boric acid, for example).

According to some embodiments, it may be desirable to include a packing modifier mixed with a metal powder build material wherein the packing modifier comprises a metallic boride and wherein the metal powder comprises the metallic component of the metallic boride. For instance, parts may be fabricated from a titanium powder mixed with a packing modifier comprising titanium boride, or from a steel powder mixed with a packing modifier comprising an iron boride. Depending upon the chemistries of the base powder and packing modifier, as well as the processing steps of the additive manufacturing process, the packing modifier comprising boron and/or a boron compound may aid in a thermal processing step of the processing steps by aiding sintering, as is the case with boron nitride as a packing modifier and silicon carbide as a base powder, for example. As a further example, in cases where the build material is in part ferrous, a packing modifier comprising an iron boride may decrease the liquid forming temperature of the build material and act as a sintering aid in the case where a processing temperature is brought to and above the point where the packing modifier behaves as a sintering aid. In still other cases where a processing temperature is below the temperature at which the metal boride behaves as a sintering aid, the metallic boride may incorporate by solid state diffusion or other related mass transport processes.

In some embodiments, a packing modifier may comprise a metal oxide powder that may undergo reduction to the metallic component of the metal oxide during at least one step of an additive manufacturing process. Such packing modifiers may be suitable in instances in which the addition of the base metallic component of the metal-oxide is not undesirable or otherwise deleterious to the additive manufacturing process. For example, in certain embodiments in which the addition of iron to the base powder is not undesirable (e.g., if a base powder comprises iron or an iron-based alloy), the packing modifier may comprise oxides of iron including, but not limited to, iron (II) oxide, iron dioxide, iron (II, III) oxide, mixed oxides of iron, iron (II) hydroxide, and iron (III) hydroxide. Such iron oxides may undergo reduction to iron during one or more processing steps of an additive manufacturing process, such as during a debinding process and/or a sintering process. After reduction, the iron may remain in the part after one or more processing steps and may combine or otherwise become integrated with the metal of the base powder in a subsequent processing step. In this manner, powder particles of the packing modifier and base powder, which may be distinguishable based on a material property or characteristic at the beginning of the additive manufacturing process, may become indistinguishable after one or more processing steps.

In other embodiments, a packing modifier may comprise other suitable metal oxides including, but not limited to, oxides of nickel, copper, chromium, vanadium, molybdenum, bismuth, lead, silver, and/or other metals or transition metals. As noted above, a particular metal oxide or combination of metal oxides may be selected such that the metallic element(s) of the metal oxide(s) are compatible with a metal of the base powder. For example, the metallic base of the metal oxide powder of the packing modifier may be the same metal as a metal in the base powder.

In some embodiments, a packing modifier may include materials that may be removed during one or more steps of an additive manufacturing process. For example, a packing modifier may include materials comprising aluminum and chloride, such as aluminum chloride and/or aluminum chlorohydrate. During processing of a manufactured part (e.g., during a debinding process, a sintering process, and/or one or more other process), the chloride and aluminum may be removed so as to not interfere with the properties of a final part formed after performing the processing step(s) on the manufactured part. Alternatively, in some embodiments in which the addition of aluminum to the base powder is not undesirable, only the chloride component may be removed. In further embodiments, the packing modifier may comprise aluminum and zirconium, such as an aluminum zirconium tetrachlorohydrex gly. Similar to the embodiments discussed previously, the cationic and chloride components of the packing modifier may be removed during processing of the manufactured part, or alternatively, only the chloride components may be removed in embodiments in which the addition of aluminum and zirconium to the base powder is not undesirable.

In further embodiments, the packing modifier may comprise one or more components that dissolve into the base powder during sintering such that the packing modifier material does not interfere with the sintering process and/or the properties of the final manufactured part. For example, suitable materials that can dissolve into the base powder during sintering include metal silicides including, but not limited to MoSi₂, WSi₂, CoSi, Co₂Si, MnSi, Mn₃Si, FeSi, Fe₃Si, (Cr, V, Mn)₃Si, CrSi, Cr₃Si, NiSi, NiSi, NiSi, Cu₃Si, CuSi₂, may at least partially dissolve into an alloy of the base powder during sintering. In other embodiments, intermetallic compounds comprising two or more metals in which one of the metals is the base metal of a metallic base powder may be suitable. Exemplary intermetallic compounds include, but are not limited to, Fe₂Ta, Fe₂Nb, FeCr, FeW, FeTi, and FeV.

Additional materials that may be suitable for the packing modifier in some applications include, but are not limited to SiC (silicon carbide), Si₃N₄ (silicon nitride), and/or materials comprising primarily anhydrous metal nitrates, such as Ti(NO₃)₄, Sn(NO₃)₄, and Zr(NO₃)₄.

Moreover, in some embodiments, the packing modifier may comprise a material that decomposes or cracks to a gaseous compound when exposed to elevated temperatures during a processing step such as a sintering process following an additive manufacturing process. The gaseous compound may escape from the manufactured part or otherwise be removed from the manufactured part so as to not interfere with the processing step. In this manner, a sintering process may allow for packing enhancement when needed (e.g., during formation of the manufactured part when the build material must be spread uniformly and/or arranged in a layer-wise manner exhibiting uniformity in particle number density per volume throughout a build volume), while substantially removing the packing modifier such that the final part is composed primarily of the material of the base powder.

In further embodiments, the packing modifier may comprise a material which decomposes upon the interaction with a material deposited from a print head during the additive manufacturing process. Such embodiments can include the enzymatic degradation of synthetic materials (e.g., materials such as poly(ethylene terephthalate), poly(methyl methacrylate), and nylon 6-6 exposed to solutions of esterase and papain) and/or natural polymeric materials (e.g., guar galactomannan or the like exposed to solutions of mannanase).

In further embodiments, the packing modifier may comprise a material which dissolves, reacts, other otherwise decomposes during a processing step prior to the thermal processing of a printed part. For example, a packing modifier can be an inorganic salt, such as a milled powder of sodium chloride, and the printed part can be exposed to an aqueous solution sufficient to dissolve the sodium chloride powder in a rinsing step prior to thermal processing where the presence of sodium chloride can be deleterious to the properties of the three-dimensional object.

In addition to the above, the inventors have recognized and appreciated that in some applications, it may be desirable to control the packing behavior and/or flowability of a build material to be within a predetermined measure of one or more packing and/or flowability measures, rather than simply maximizing the packing and/or flowability of the build material. In particular, the inventors have appreciated that a build material that flows too easily may not provide enough mechanical stability to layers formed during an additive manufacturing process and/or one or more subsequent processing steps, and that formation of subsequent layers may cause previously formed layers to shift. The occurrence of shifting is generally undesirable, and may result in final manufactured objects lacking required tolerances and/or dimensional accuracy, or objects that fail either during the additive manufacturing process or during one or more subsequent post-processing steps. Accordingly, in some embodiments, an amount of packing modifier to be added to a base powder may be selected to provide a desired degree of flowability. In this manner, the packing modifier described herein may permit tuning of the flowability and packing behavior of a build material for various applications and materials systems to achieve a desired response.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

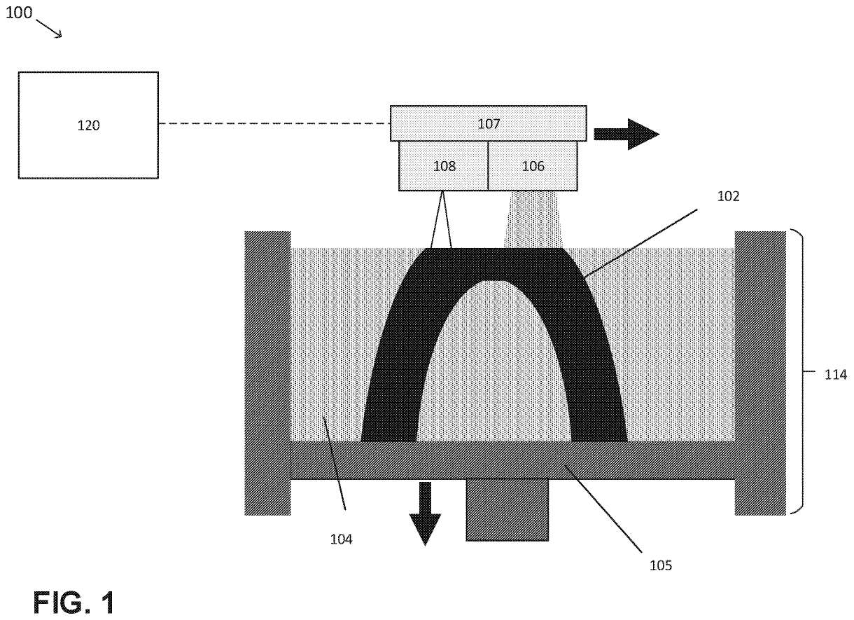

Referring to FIG. 1 an additive manufacturing apparatus 100 is used to form a three-dimensional object 102 from a build material 104. As described above the build material 104 may comprise a base powder and one or more packing modifiers. The three-dimensional object 102 may be referred to as a manufactured part (green part) or a printed object, and as described in greater detail below, the manufactured part can be subsequently processed (e.g., sintered) to form a finished part. It should be understood that the current disclosure is not limited to any particular type of additive manufacturing process. For example, as described in more detail below, the system 100 depicted in FIG. 1 utilizes a binder jetting process to selectively join a portion of the build material within a layer of a manufactured part. Other suitable systems to selectively join a portion of the build material include, but are not limited to, powder fusion processes such as selective laser melting processes.

The additive manufacturing apparatus 100 can include a powder deposition mechanism 106 and a print head 108, which may be coupled to and moved across the print area by a unit 107. The material deposition mechanism 106 may be operated to deposit build material 104 onto the powder bed 114. In some cases, an additional device such as a roller may be operated to move over the deposited build material to spread the build material evenly over the surface. For instance, a spreader may include a roller rotatable about an axis perpendicular to an axis of movement of the spreader across the powder bed 114. Such a roller can be, for example, substantially cylindrical. The additive manufacturing apparatus 100 may configured to form layers of build material on the powder bed having any suitable geometry, and a layer of build material as referred to herein does not necessarily refer to a homogeneous, planar layer.

The print head 108 may include one or more orifices through which a liquid (e.g., a binder) can be delivered from the print head 108 to each layer of the build material 104 along the powder bed 114. In certain embodiments, the print head 108 can include one or more piezoelectric elements, and each piezoelectric element may be associated with a respective orifice and, in use, each piezoelectric element can be selectively actuated such that displacement of the piezoelectric element can expel liquid from the respective orifice. In some embodiments, the print head 108 may be arranged to expel a single liquid formulation from the one or more orifices. In other embodiments, the print head 108 may be arranged to expel a plurality of liquid formulations from the one or more orifices. For example, the print head 108 can expel a plurality of solvents, a plurality of components of a binder system, or both from the one or more orifices. Moreover, in some instances, expelling or otherwise delivering a liquid from the print head may include emitting an aerosolized liquid (i.e., an aerosol spray) from a nozzle of the print head.

In general, the print head 108 may be controlled to deliver liquid such as a binder to the powder bed 114 in predetermined two-dimensional patterns, with each pattern corresponding to a respective layer of a three-dimensional object. In this manner, the delivery of the binder may refer to a printing operation in which the build material 104 in each respective layer of the three-dimensional object is selectively joined along the predetermined two-dimensional layers. After each layer of the object is formed as described above, the platform 105 may be moved down and a new layer of powder deposited, binder again applied to the new powder, etc. until the object has been formed.

In some embodiments, the print head 108 can extend axially along substantially an entire dimension of the powder bed 114 in a direction perpendicular to a direction of movement of the print head 108 across the powder bed 114. For example, in such embodiments, the print head 108 can define a plurality of orifices arranged along the axial extent of the print head 108, and liquid can be selectively jetted from these orifices along the axial extent to form a predetermined two-dimensional pattern of liquid along the powder bed 114 as the print head 108 moves across the powder bed 114. In some embodiments, the print head 108 may extend only partially across the powder bed 114, and the print head 108 may be movable in two dimensions relative to a plane defined by the powder bed 114 to deliver a predetermined two-dimensional pattern of a liquid along the powder bed 114.

The additive manufacturing apparatus 100 further includes a controller 120 in electrical communication with the unit 107, the material deposition mechanism 106 and the print head 108. Controller 120 is configured to control the motion of unit 107, the material deposition mechanism 106 and the print head 108 as described above. A non-transitory, computer readable storage medium may be in communication with the controller 120 and have stored thereon a three-dimensional model and instructions for carrying out any one or more of the methods described herein. Alternatively, the non-transitory, computer readable storage medium may comprise previously prepared instructions that, when executed by the controller 120, operate the platform 105, unit 107, material deposition mechanism 106 and print head 108 to fabricate one or more parts. For example, one or more processors of the controller 120 can execute instructions to move the unit 107 forwards and backwards along an x-axis direction across the surface of the powder bed 114. One or more processors of the controller 120 also may control the material deposition mechanism 106 to deposit build material onto the powder bed 114.

In some embodiments, one or more processors of the controller 120 may control the print head 108 to deposit liquid such as a binder onto selected regions of the powder bed to deliver a respective predetermined two-dimensional pattern of the liquid to each new layer of the powder 104 along the top of the powder bed 114. In general, as a plurality of sequential layers of the powder 104 are introduced to the powder bed 114 and the predetermined two-dimensional patterns of the liquid are delivered to each respective layer of the plurality of sequential layers of the powder 104, the three-dimensional object 102 is formed according to a three-dimensional model (e.g., a model stored in a non-transitory, computer readable storage medium coupled to, or otherwise accessible by, the controller 120). In certain embodiments, the controller 120 may retrieve the three-dimensional model in response to user input, and generate machine-ready instructions for execution by the additive manufacturing apparatus 100 to fabricate the three-dimensional object 102.

It will be appreciated that the illustrative additive manufacturing apparatus 100 is provided as one example of a suitable additive manufacturing apparatus and is not intended to be limiting with respect to the techniques described herein for controlling the packing and/or flow behavior of a build material. For instance, it will be appreciated that the techniques may be applied within an additive manufacturing apparatus that utilizes only a roller as a material deposition mechanism and does not include material deposition mechanism 106. Furthermore, the techniques may be applied to other powder-based additive manufacturing apparatus, including those that form cohesive regions of material via application of directed energy rather than via deposition of a liquid. Such systems may for instance include direct metal laser sintering (DMLS) systems.

According to some embodiments, the techniques described herein for controlling the packing and/or flow behavior of a build material may be employed to control properties of a build material for a binderjet additive manufacturing system. Such a system may comprise additive manufacturing apparatus 100 in addition to one or more other apparatus for producing a completed part. Such apparatus may include, for example, a furnace for sintering a green part fabricated by the additive manufacturing apparatus 100 (or for sintering such a green part subsequent to applying other post-processing steps upon the green part).

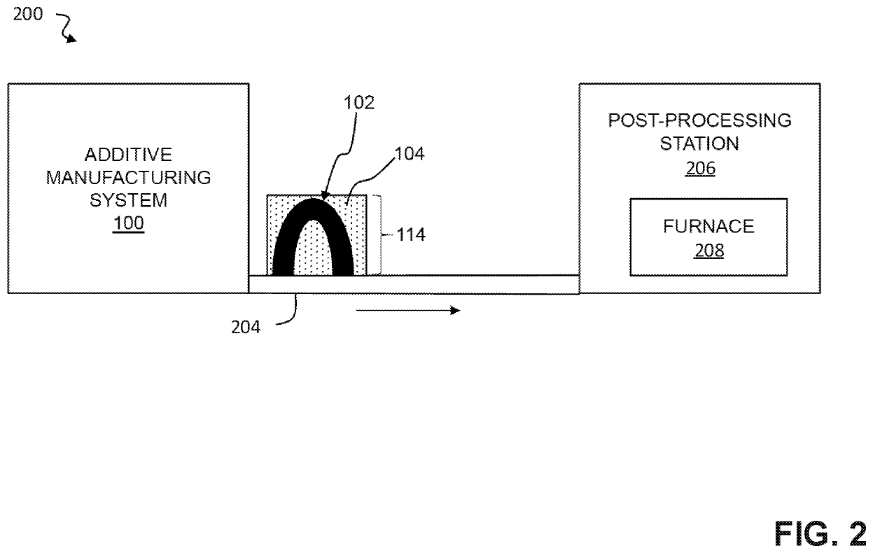

As one example of such an additive manufacturing system, FIG. 2 depicts an additive manufacturing plant 200 that includes the additive manufacturing apparatus 100 shown in FIG. 1, a conveyor 204, and a post-processing station 206. The powder bed 114 containing the three-dimensional object 102 can be moved along the conveyor 204 and into the post-processing station 206. The conveyor 204 can be, for example, a belt conveyor movable in a direction from the additive manufacturing apparatus 100 toward the post-processing station. Additionally, or alternatively, the conveyor 204 can include a cart on which the powder bed 114 is mounted and, in certain instances, the powder bed 114 can be moved from the additive manufacturing apparatus 100 to the post-processing station 206 through movement of the cart (e.g., through the use of actuators to move the cart along rails or by an operator pushing the cart).

In the post-processing station 206, the three-dimensional object 102 can be removed from the powder bed 114. The build material 104 remaining in the powder bed 114 upon removal of the three-dimensional object 102 can be, for example, recycled for use in subsequent fabrication of additional parts. According to some aspects, the packing modifiers described herein may aid in maintaining a desired packing and/or flow characteristic of the base build material after recycling, thereby allowing for improved consistency in manufactured parts when utilizing recycled build material. Additionally, or alternatively, in the post-processing station 206, the three-dimensional object 102 can be cleaned (e.g., through the use of pressurized air) of excess amounts of the build material 104.

In systems employing a binder jetting process, the three-dimensional object 102 can undergo one or more debinding processes in the post-processing station 206 to remove all or a portion of the binder system from the three-dimensional object 102. In general, it shall be understood that the nature of the one or more debinding processes can include any one or more debinding processes known in the art and is a function of the constituent components of the binder system. Thus, as appropriate for a given binder system, the one or more debinding processes can include a thermal debinding process, a supercritical fluid debinding process, a catalytic debinding process, a solvent debinding process, and combinations thereof. For example, a plurality of debinding processes can be staged to remove components of the binder system in corresponding stages as the three-dimensional object 102 is formed into a finished part.

The post-processing station 206 can include a furnace 208. The three-dimensional object 102 can undergo sintering in the furnace 208 such that the particles of the base powder 106 combine with one another to form a finished part. As discussed above, in some embodiments, one or more components of the packing modifier 108 also may combine with the base powder during sintering to form the final part. Additionally, or alternatively, one or more debinding processes can be performed in the furnace 208 as the three-dimensional object 102 undergoes sintering, and/or the one or more debinding processes can be performed outside of the furnace 208.

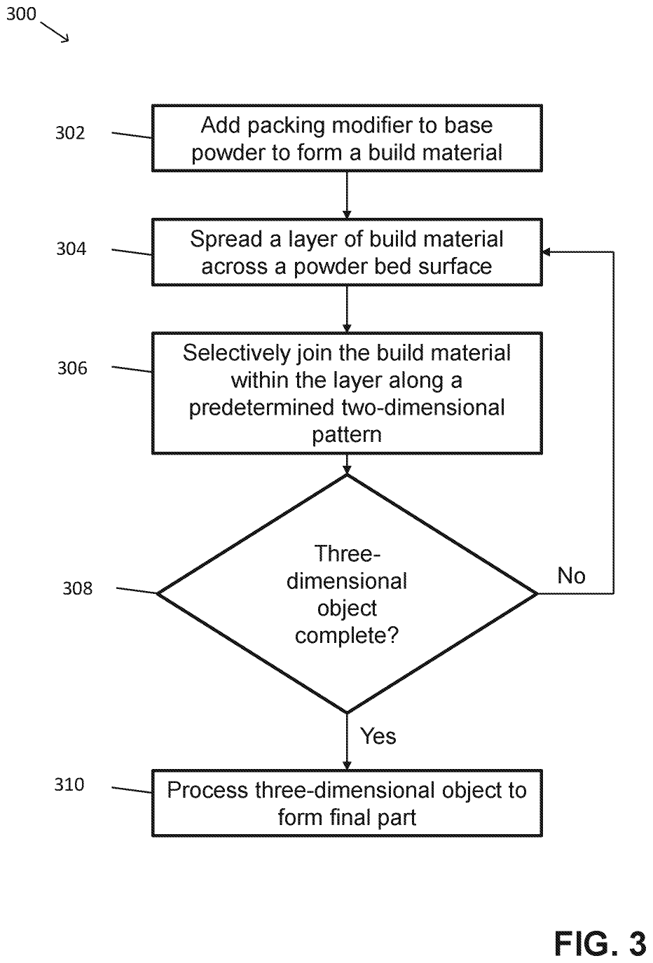

FIG. 3 is a flowchart of an exemplary method 300 of fabricating a three-dimensional object (e.g., a printed part) with an additive manufacturing process. The method 300 can be implemented using any one or more of the various different additive manufacturing systems described herein. For example, the method 300 can be implemented as computer-readable instructions stored on a storage medium and executable by the controller 120 to operate the additive manufacturing apparatus 100 as shown in FIG. 1.

As shown in act 302, the method 300 includes adding a packing modifier to a base powder to form a build material. Depending on the particular embodiment, the packing modifier may be added to the base powder using conventional powder blending techniques such as mixing the powders in a v-blender, mixing the powders in a high-shear mixer, hand stirring the powders, shaking the powders in a jar, and so on. In some embodiments, at least part of act 302 may be performed within an additive fabrication apparatus (e.g., apparatus 100 shown in FIG. 1). In some embodiments, act 302 is performed as a preparatory step separate and distinct from the subsequent acts 304, 306 308 and 310 in which the object is fabricated, and may be performed by any user at any location, and not necessarily by the same user that operates the additive fabrication apparatus nor at the same location.

Irrespective of where and when the packing modifier is added to the base powder to form a build material, in some embodiments, in act 302 the packing modifier may be added to the base powder in multiple blending steps. For instance, a first blending step may involve adding packing modifier to the base powder to form a precursor powder comprising a higher concentration of packing modifier compared to the final build material. During this first step, a high shear blending technique may be employed to promote more complete dispersion and deagglomeration of the packing modifier. Subsequently, the precursor powder may be combined with additional base powder in a second blending step to achieve a desired concentration of packing modifier in the build material. Accordingly, it should be understood that the current disclosure is not limited to any particular technique or combinations of techniques for adding the packing modifier to the base powder, or for dispersing the packing modifier in the base powder.

As shown at act 304, the method 300 includes spreading a layer of the build material across a powder bed. The build material may include any suitable combination of base powders and packing modifiers as described herein. Moreover, it should be understood that spreading the layer of build material may involve using any suitable deposition process to deposit a layer of the build material across the powder bed, and that the layer of build material may have any suitable geometry. In particular, it should be understood that the word layer as used herein does not necessarily refer a homogeneous, planar layer, but may be refer to any structure exhibiting a generally layer-like geometry. For example, a layer may not be planar, but may have a tortuous geometry in three dimensional space while maintaining a substantially two-dimensional character in many locations locally. In some instances, a layer may be discontinuous or may exhibit a perforated structure. A layer may generally have a two-dimensional geometry, but may exhibit a characteristic along a third dimension, such as a thickness. The thickness a particular layer may be constant or variable within the layer, and in some locations, the thickness of the layer may be zero. It should be understood that the deviations of a layer from the absolute planarity and constant thickness may occur due to process non-idealities (e.g., a lack of planarity of a spreading device with respect to a prior flat layer of powder, notches or abrasions in the spreading devices, and/or unintended or otherwise incidental machine vibrations). Alternatively or additionally, deviations in a layer may occur as intentional aspects of the fabrication process (e.g., a non-constant layer height to increase build rate in certain regions, a tilted spreading device to facilitate powder flow, etc.). It should further be understood that the characteristics of a layer, such as the thickness and/or geometry of a layer, may vary from one layer to a next, as well as within a layer. Moreover, a layer may comprise a mixture of several materials at microscopic and/or macroscopic length scales. Accordingly, it should be understood that the current disclosure is not limited to any particular layer structure formed by spreading the build material across the powder bed surface.

As shown at act 306, the method 300 further includes selectively joining the build material within the layer along a predetermined two-dimensional pattern. For example, in a binder jetting process, selectively joining the build material may involve jetting a fluid to the layer of build material along a controlled two-dimensional pattern associated with the layer. The fluid can be jetted from a print head, and the fluid may comprise one or more components of a binder system.

As shown at act 308, the method includes repeating the steps of spreading a layer of the build material across the powder bed and selectively joining the build material along a predetermined two-dimensional pattern for each layer of a plurality of sequential layers to form a three-dimensional object (i.e., a printed part or a manufactured part) in the powder bed. It should be appreciated that the predetermined two-dimensional pattern in each layer can vary from layer to layer in the plurality of sequential layers, particularly in instances in which the three-dimensional object being formed from the predetermined two-dimensional patterns has a complex shape. Moreover, it should be understood that depending on the particular additive manufacturing process, joining a portion of the build material within a particular layer may also join at least a portion of the layer to at least one previously joined layer, such as a layer formed immediately prior to the particular layer.

After a three-dimensional object is formed, one or more post-processing steps (e.g., debinding processes, and/or sintering processes) may be performed to form a final part as shown at act 310. Such post-processing steps may in some cases include a step to cure, dry, crosslink and/or harden the binder liquid.

As noted above, although additive manufacturing processes involving jetting a binder onto a powder bed are described above, it should be understood that the current disclosure is not limited to any particular type additive manufacturing process. For example, the packing modifiers described herein may be suitable for any of a variety of powder-based additive manufacturing processes, including, but not limited to, binder jetting processes, powder bed fusion processes (e.g., direct laser melting and/or selective laser melting processes), or any other suitable additive manufacturing processes in which layers of build material are selectively joined and/or consolidated along two-dimensional patterns to build up a three-dimensional object.

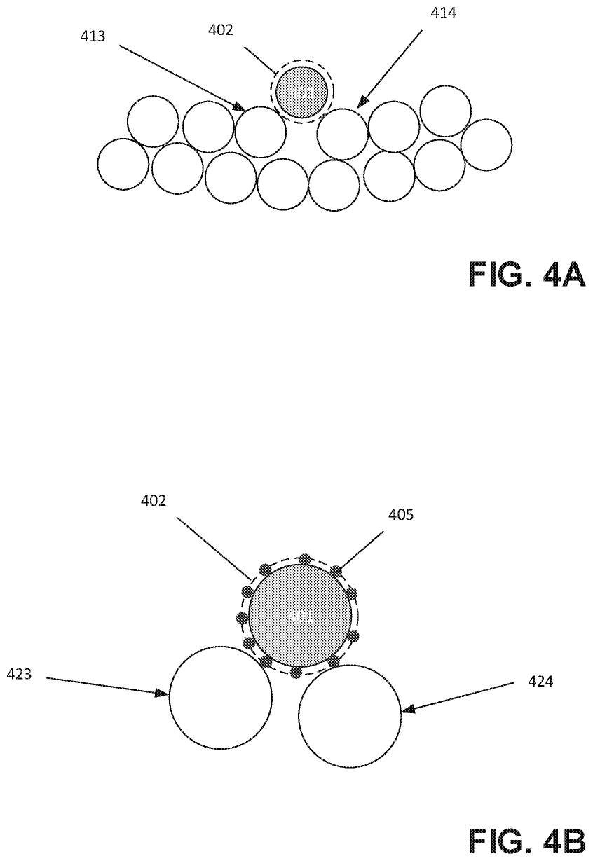

To illustrate how the aforementioned packing modifier(s) may control the flow and/or packing behavior of a build material, FIGS. 4A-4B illustrate interactions between particles of a build material without and with an included packing modifier, respectively, according to some embodiments. In the example of FIG. 4A, a plurality of particles of a base powder are illustrated as circles, with one of the base powder particles 401 being shaded to highlight the particle for purposes of illustration and description. The illustrative particle 401 is surrounded by a circle 402 that represents the radius of interparticle interactions. That is, particles within the circle may interact with one another via interparticle interaction forces, which may for instance include van der Waals forces. The other powder particles are assumed to exhibit commensurate radii of interparticle interactions, although these radii are not shown in FIG. 4A for clarity. Particles may also interact with one another through mechanical contact forces.

During use of the base powder represented by the particles shown in FIG. 4A, an external force may be exerted onto any number of individual particles within the collection. Such an external force applied to a particle may include interparticle forces from one or more other particles, forces applied to the particle from a piece of machinery (e.g., a spreading or depositing mechanism in an additive fabrication device), a stationary boundary (e.g., a wall or floor of a container, an electromagnetic force, gravity, and/or any other surface or body force. In responding to an external force, a given particle may interact with the nearest neighboring particles through mechanical and/or interparticle forces.

Because interparticle forces tend to pull the particles together, base powders may tend to “clump” because the particles of powder tend to cohere to one another. This behavior can lead to a lack of flowability of the powder which, as discussed above, may be undesirable in additive fabrication at least in part because it may also lead to uneven packing of the powder.

FIG. 4B depicts the base powder of FIG. 4A where particles of a packing modifier have been added to the base powder. The example of FIG. 4B focuses on the base powder particles 401 and neighboring particles 423 and 424, and illustrates packing modifier particles 405 around only the particle 401 for purposes of explanation and clarity. In the example of FIG. 4B, the packing modifier particles 405 cause neighboring particles 423 and 424 to lie outside the radius of interparticle interactions 402. As a result, when an external force is applied to particle 401, the same mechanical contact and interparticle forces are present as in the example of FIG. 4A, but owing to the packing modifier particles 405, particle 401 is separated from direct contact with the particles 423 and 424 and interparticle forces are reduced or removed. Motion of particle 401 in the example of FIG. 4B is thereby driven largely by interactions between particles via the packing modifier rather than direct particle to particle interactions as in the example of FIG. 4A. By controlling the properties of the packing modifier relative to the base powder particles, such as the relative size of the base powder and packing modifier particles, the flowability of the powder may be controlled.

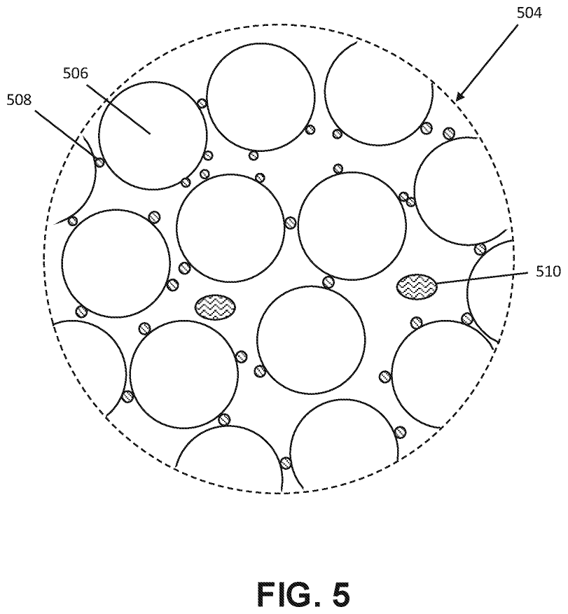

To further illustrate the structure of a build material comprising a base powder and a packing modifier, FIG. 5 illustrates a portion of such a build material. As illustrated in the example of FIG. 5, particles of a base powder 506 are mixed with particles of a packing modifier 508. As shown in the example of FIG. 5, packing modifier 508 may comprise a powder, and the particles of the packing modifier may be generally smaller than the particles of the base powder 506. The packing modifier particles may be interspersed between the base powder particles, thereby reducing the interparticle cohesion between the particles of the base powder 506 as discussed above (e.g., due to reduced contact between the particles of the base powder). In some instances, a shear force applied to the build material 504 may result in a rolling action between the particles of the base powder 506 and the packing modifier 508, which may facilitate improved packing and increased flowability of the build material. However, it should be understood that other mechanisms to improve the packing behavior of the build material also may be suitable, as the current disclosure is not limited in this regard.

As depicted in FIG. 5, the particles of the packing modifier 508 may have a size that is generally smaller than a particle size of the base powder 506, though other arrangements, such as embodiments in which the packing modifier and base powder have similar sizes, or in which the packing modifier is larger, are also contemplated. In one exemplary embodiment, the base powder 506 has a D50 of about 12 microns, a D10 of about 5 microns, and a D90 of about 25 microns. In other embodiments, the D50 of the base powder may be as small as 5 microns and the D10 may be as small as 1 micron. Moreover, an average particle size of the packing modifier may range from about 5 nanometers to about 500 nanometers, such as between about 10 nm and about 250 nm, between about 25 nm and about 100 nm, and/or between about 50 nm and about 75 nm. For example, in one exemplary embodiment, a packing modifier may have a primary particle size between about 12 nm and about 100 nm.

In some embodiments, a particle size of the particles comprising the base powder may be up to about 2000 times larger than a particle size of the particles comprising the packing modifier. For example, the particle size of the base powder may be between about 5 times larger and about 2000 times larger, between about 10 times larger and about 1000 times larger, between about 20 times larger and about 500 times larger, between about 30 times larger and about 100 times larger, and/or between about 40 times larger and about 75 times larger than the particle size of the packing modifier. It should be understood that the particle sizes and particle size distributions described herein can be characterized using any suitable method, including but not limited to, laser diffraction particle size analysis, and scanning electron microscopy (SEM).

In some embodiments, a particle size of the particles comprising the packing modifier may be sufficiently small relative to a particle size of the particles comprising the base powder that the packing modifier acts as a coating. That is, the packing modifier may coat the base powder particles.

While the base powder 506 and packing modifier 508 may be generally depicted herein as spherical, it should be understood that the particles may have any suitable shape and/or morphology. For example, in some embodiments, the various particles may exhibit morphologies ranging from smooth, spherical particles to particles exhibiting a high fractal dimension structure, such as fumed particles or precipitated particles. In some instances, a build material may comprise various combinations of particles with different shapes and/or morphologies. Moreover, while each of the base powder and packing modifier are depicted as comprising particles with a generally uniform size distribution, it should be understood that various non-uniform distributions for the particle sizes may be suitable. Accordingly, it should be understood that the current disclosure is not limited to any particular combinations of particle shapes, morphologies, and/or size distributions.

As discussed above, the packing modifier 508 may be added to the base powder 506 in an amount suitable to achieve a desired packing behavior for the base powder. For example, the build material 504 may comprise between about 0.01 percent and about 10 percent, between about 0.1 and about 5 percent, and/or between about 1 and about 3 percent by weight of the packing modifier 508, with the remainder of the build material being comprised of the base powder 506. Additionally, in embodiments in which the build material comprises at least one component 510 of a binder system, the binder may comprise between about 1 percent and about 20 percent by weight of the build material.

Depending on the particular embodiment, the base powder 506 may comprise any suitable metallic and/or ceramic components. For example, the base powder 506 can be a single fine elemental powder, such as a powder of tungsten, copper, nickel, cobalt, iron, or a precious metal. As another example, the base powder 508 can be a single alloy powder (e.g., 316L stainless steel, 17-4 PH stainless steel, Co—Cr—Mo powder, or F15 powder). As used herein, a single material shall be understood to allow for impurities at levels associated with powder handling of metals and, further or instead, to allow for impurities in predetermined amounts of impurities specified for a three-dimensional object. Moreover, in some embodiments, the base powder 506 may comprise a plurality of materials. For example, a ratio of the plurality of materials in the base powder 506 can be set to in a predetermined ratio suitable for alloying with one another to achieve a target alloy composition upon sintering a part fabricated from the build material. As an additional or alternative example, the base powder 506 can include material components of stainless steel. As another specific example, the base powder 506 can include two or more of tungsten, copper, nickel, cobalt, and iron.

In embodiments in which the base powder 506 comprises a plurality of materials, the base powder 506 may alloy to form a different material. For example, the base powder 506 can include tungsten carbide having a submicron average particle size and cobalt having an average particle size of about 1 micron. These particles can be sintered to form a tungsten-carbide-cobalt based hard metal. As an example of such a tungsten-carbide-cobalt based hard metal, the base powder 506 can include fine stainless steel and tungsten carbide and cobalt such that sintering a part fabricated from a build material that includes these materials can form unique microstructures in a stainless-steel matrix. More specifically, these unique microstructures can be areas of tungsten carbide-cobalt in a stainless-steel matrix, with these areas having high hardness that can advantageously improve wear resistance of the finished part, as compared to the wear resistance of the finished part without such areas of high hardness.

Alternatively, the base powder 506 can include materials that do not alloy with one another (e.g., tungsten and copper or molybdenum and copper). Moreover, the plurality of materials in the base powder 506 can have different average particle sizes, with one of the materials being much finer than another one or more of the materials. Because sinter temperature of particles is a function of the size of the particles, differences in the sizes of the different materials included the base powder 506 can be useful for achieving sintering at a target temperature.

In some embodiments, the at least one component 510 of the binder system can include an organic binder such as, for example, an organic binder that is soluble in water or other liquid jetted from a print head. Additionally, or alternatively, the at least one component 510 of the binder system can include one or more polymers. Examples of such polymers include polyethylene glycol (PEG), polyethylene, polylactic acid, polyacrylic acid, polypropylene, and combinations thereof.

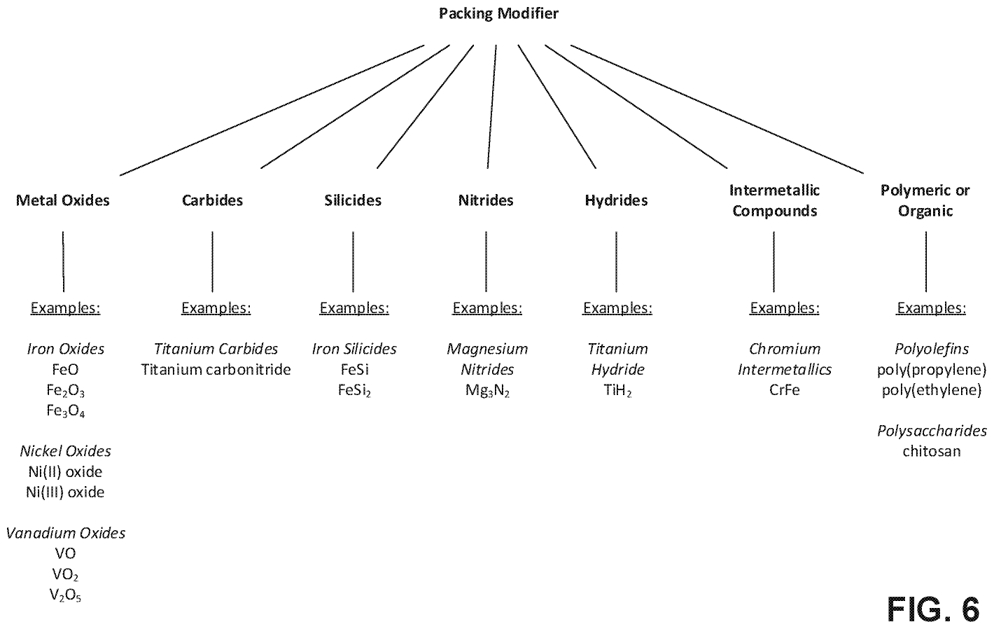

FIG. 6 depicts illustrative materials that may be utilized as a packing modifier, according to some embodiments. While a more detailed list of suitable packing modifier materials is provided in Table 1 below, for purposes of illustration FIG. 6 depicts a hierarchical view of certain preferred materials for a packing modifier. As shown in the example of FIG. 6, a packing modifier may comprise metal oxides, carbides, silicides, nitrides, intermetallic compounds, polymeric/organic materials, or combinations thereof. As an example of suitable metal oxides that may be selected as a packing modifier (or as a component of a packing modifier), iron oxides, nickel oxides and vanadium oxides are depicted in FIG. 6. Similar sub-classes are shown for the other broad categories of packing modifier in the figure.

According to some embodiments, a packing modifier may include any one or more of the materials shown in Table 1 below.

TABLE 1

| Primary Category | Secondary Category | Tertiary Category | Quaternary Category |
|---|---|---|---|
| Metal oxides | of Antimony | Sb O₂ | |
| | | Sb₂ O₃ | |
| | | Sb₂ O₅ | |
| | of Arsenic | AS₂ O₃ | |
| | | AS₂ O₅ | |
| | | Arsenic oxide hydrate | |
| | of Barium | | |
| | of Beryllium | | |
| | of Bismuth | | |
| | of Boron | | |
| | of Cadmium | | |
| | of Calcium | calcium oxide | |
| | | calcium peroxide | |
| | of Cerium | | |
| | of Cesium | | |
| | of Chromium | Cr(III) oxide | |
| | | Cr(IV) oxide | |
| | | Cr trioxide | |
| | of Cobalt | Co(II) oxide | |
| | | Co(III) oxide | |
| | | Co(II, III) oxide | |
| | of Copper | Cu(I) oxide | |
| | | Cu(II) oxide | |
| | of Dysprosium | | |
| | of Erbium | | |
| | of Europium | | |
| | of Gadolinium | | |
| | of Gallium | | |
| | of Germanium | | |
| | of Gold | Gold oxide | |
| | | Digold oxide | |
| | of Hafnium | | |
| | of Holmium | | |
| | of Indium | | |
| | of Iodine | | |
| | of Iridium | Iridium oxide | |
| | | Iridium (IV) oxide hydrate | |
| | of Iron | Fe O | |
| | | Fe₂ O₃ | |
| | | Fe₃ O₄ | |
| | of Lanthanum | | |
| | of Lead | Lead oxide | |
| | | Lead(II) oxide | |
| | | Lead(II, IV) oxide | |
| | of Lithium | | |
| | of Lutetium | | |
| | of Magnesium | Magnesium oxide | |
| | | Magnesium peroxide | |
| | | Magnesium peroxide | |
| | | complex | |
| | of Manganese | Mn O | |
| | | Mn O₂ | |
| | | Mn₂ O₃ | |
| | | Mn₃ O₄ | |
| | of Mercury | | |
| | of Molybdenum | Molybdenum oxide | |
| | | Mo (IV) oxide | |
| | of Neodymium | | |
| | of Nickel | Ni(II) oxide | |
| | | Ni(III) oxide | |
| | | Ni(II) peroxide | |
| | | Ni(II) peroxide hydrate | |
| | of Niobium | NbO | |
| | | Nb O₂ | |
| | | Nb₂ O₅ | |
| | of Osmium | Os O₂ | |
| | | Os O₄ | |
| | of Palladium | Palladium oxide | |
| | | Palladium dioxide | |
| | of Platinum | Platinum oxide | |
| | | Platinum (IV) oxide | |
| | | hydrate | |
| | | Platinum (IV) oxide | |
| | | monohydrate | |
| | of Potassium | | |
| | of Praseodymium | Pr₂ O₃ | |
| | | Pr₆ O₁₁ | |
| | of Rhenium | Re O₂ | |
| | | Re O₃ | |
| | | Re₂ O₇ | |
| | of Rhodium | | |
| | of Rubidium | | |
| | of Ruthenium | | |
| | of Samarium | | |
| | of Scandium | | |
| | of Selenium | | |
| | of Silicon | SiO₂ | |
| | | SiO | |
| | of Silver | | |
| | of Sodium | | |
| | of Strontium | | |
| | of Tantalum | | |
| | of Tellurium | | |
| | of Terbium | | |
| | of Thallium | | |
| | of Thorium | | |
| | of Thulium | | |
| | of Tin | Sn O | |
| | | Sn O₂ | |
| | of Titanium | Ti O | |
| | | Ti O₂ | |
| | | Ti₂ O₃ | |
| | | Ti₃ O₅ | |
| | of Tungsten | W O₂ | |
| | | W O₃ | |
| | of Uranium | | |
| | of Vanadium | V O | |
| | | V O₂ | |
| | | V₂ O₅ | |
| | of Ytterbium | | |
| | of Yttrium | | |
| | of Zinc | | |
| | of Zirconium | | |
| Carbides | with Aluminum | Al₄ C₃ | |
| | with Magnesium | Mg₂ C | |
| | with Beryllium | Be₂ C | |
| | with Silicon | Si C | |
| | with Boron | | |
| | with Bismuth | | |
| | with Chrome | Cr₂₃ C₆ | |
| | | Cr₇ C₃ | |
| | with Cobalt | | |
| | with Copper | | |
| | with Manganese | Mn₂₃ C₆ | |
| | | Mn₃ C | |
| | | Mn₅ C₂ | |
| | with Molybdenum | Mo₂ C | |
| | | Mo C | |
| | with Mo and H | MHC alloy | |
| | with Niobium | Nb C | |
| | | and aluminum | Nb Al C |
| | with Palladium | | |
| | with Platinum | | |
| | with Rhenium | | |
| | with Rhodium | | |
| | with Ruthenium | | |
| | with Rubidium | | |
| | with Silicon and | silicon oxycarbide | |
| | Oxygen | | |
| | with Silicon and | Si N C | |
| | Nitrogen | | |
| | with Silicon | Si C₆ | |
| | | SiC | |
| | with Silver | Ag C | |
| | with Strontium | Sr C | |
| | with Tantalum | Ta₂ C | |
| | | Ta C | |
| | | and Hafnium | Ta Hf C |
| | | and Niobium | Ta Nb C |
| | with Tellurium | | |
| | with Terbium | | |
| | with Thallium | | |
| | with Thulium | | |
| | with Tin | | |
| | with Titanium | Ti C | |
| | | and Aluminum | Ti Al C |
| | | and Boron | Ti B C |
| | | and Nitrogen | Titanium carbonitride |
| | | and silicon | Titanium silicocarbide |
| | with Tungsten | W C | W (IV) C |
| | | and copper | Tungsten carbide copper |
| | | | alloy |
| | | and silver | W Ag C |
| | | and cobalt | |
| | | and titanium | tungsten titanium carbide |
| | with Vanadium | V C | |
| | with Ytterbium | | |
| | with Yttrium | | |
| | with Zinc | | |
| | with Zirconium | Zr C | |
| Silicides | with Boron | | |
| | with Barium | | |
| | with Calcium | | |
| | with Cerium | | |
| | with Chromium | Cr₃ Si₂ | |
| | | Cr₃ Si | |
| | with Cobalt | | |
| | with Copper | | |
| | with Dysprosium | | |
| | with Erbium | | |
| | with Europium | | |
| | with Gadolinium | | |
| | with Germanium | | |
| | with Hafnium | | |
| | with Iridium | | |
| | with Iron | Fe Si | |
| | | Fe Si₂ | |
| | with Lanthanum | | |
| | with Lithium | | |
| | with Lutetium | | |
| | with Magnesium | | |
| | with Molybdenum | Mo Si | |
| | | Mo Si₂ | |
| | | Mo₅ Si₃ | |
| | with Neodymium | | |
| | with Nickel | Ni Si | |
| | | Ni Si₂ | |
| | with Niobium | Nb₅ Si₃ | |
| | | Nb Si₂ | |
| | with Palladium | | |
| | with Platinum | | |
| | with Praesodyminum | | |
| | with Rhenium | | |
| | with Samarium | | |
| | with Sodium | | |
| | with Strontium | | |
| | with Tantalum | | |
| | with Terbium | | |
| | with Thulium | | |
| | with Titanium | Ti Si₂ | |
| | | Ti₅ Si₃ | |
| | with Tungsten | | |
| | with Vanadium | | |
| | with Ytterbium | | |
| | with Yttrium | | |
| | with Zirconium | | |
| Nitrides | with Aluminum | Al N | |
| | | and Gallium | Al Ga N |
| | | Aluminum Oxynitride | |
| | with Antimony | | |
| | with Barium | | |
| | with Beryllium | | |
| | with Boron | | |
| | with Cadmium | | |
| | with Calcium | | |
| | with Chromium | | |
| | with Copper | | |
| | with Dichromium | | |
| | with Dysprosium | | |
| | with Erbium | | |
| | with Europium | | |
| | with Gadolinium | Gd N₃ | |
| | | GD N | |
| | with Gallium | | |
| | with Germanium | | |
| | with Graphitic Carbon | | |
| | with Hafnium | Hafnium Nitride | |
| | | Hafnium Carbonitride | |
| | with Holmium | | |
| | with Indium | Indium nitride | |
| | | Indium Gallium nitride | |
| | with Iron | Fe₂ N | |
| | | Fe₄ N | |
| | with Lanthanum | | |
| | with Lithium | | |
| | with Lutetium | | |
| | with Magnesium | | |
| | with Manganese | Mn₃ N₂ | |
| | | Mn₄ N | |
| | with Molybdenum | Mo N | |
| | | Mo₂ N | |
| | with Neodymium | Nd N | |
| | | Nd N₃ | |
| | with Niobium | | |
| | with Praseodymium | | |
| | with Samarium | | |
| | with Scandium | | |
| | with Silicon | Si₃N₄ | |
| | | Silicon oxynitride | |
| | with Sodium | | |
| | with Strontium | | |
| | with tantalum | | |
| | with Terbium | | |
| | with Thulium | | |
| | with Titanium | Titanium carbonitride | |
| | | Titanium nitride | |
| | with Tungsten | W₃ N₂ | |
| | | W N | |
| | with Vanadium | | |
| | with Ytterbium | | |
| | with Yttrium | | |
| | with Zinc | | |
| | with Zirconium | | |
| Hydrides | with Titanium | | |
| | with Zirconium | | |
| | with Hafnium | | |
| | with Scandium | | |
| | with Yttrium | | |
| | with Aluminum | | |
| | with Vanadium | | |
| | with Magnesium | | |
| | with Lithium | | |
| | with Beryllium | | |
| | with Palladium | | |
| | with Nickel | | |
| Borides | of aluminum | AlB₂ | |
| | of carbon | CB₄ | |
| | of cobalt | CoB | |
| | | Co₂B | |
| | of copper | CuB | |
| | of chromium | CrB₂ | |
| | of ion | BFe | |
| | | BFe₂ | |
| | of nickel | NiB | |
| | | Ni₂B | |
| | of nitrogen | BN | |
| | of silicon | SiB₃ | |
| | of tantalum | TaB | |
| | | TaB₂ | |
| | of titanium | TiB₂ | |
| | of zirconium | ZrB₂ | |
| Elemental boron | | | |
| Boron oxides | with oxygen | B₂O | |
| | | B₆O | |
| | | with hydrogen | H₃BO₃ |
| Carbonates | with Manganese | MnCO₃ | |
| | with Iron | FeCO₃ | |
| | with Cobalt | CoCO₃ | |
| | with Nickel | NiCO₃ | |
| | with Copper | CuCO₃ | |
| Intermetallic | Silver intermetallics | soluble as an alloying | Ag Au |
| compounds | | element with gold | |
| | | soluble as an alloying | Ag₅ Ba₃ |
| | | element with barium | |
| | | | Ag₃ Ba₂ |
| | | soluble as an alloying | Ag Be₂ |
| | | element with Beryllium | |
| | | soluble as an alloying | AgCe |
| | | element with Cerium | |
| | | | Ag₂ Ce |
| | | soluble as an alloying | Ag In₂ |
| | | element with Indium | |
| | | soluble as an alloying | Ag Li |
| | | element with Lithium | |
| | | soluble as an alloying | Ag₃ Mg |
| | | element with magnesium | |
| | | | Ag Mg₃ |
| | | soluble as an alloying | Ag₂ Na |
| | | element with sodium | |
| | | soluble as an alloying | Ag₂ S |
| | | element with Sulfur | |
| | | soluble as an alloying | Ag Ti₂ |
| | | element with titanium | |
| | | | Ag Ti |
| | | soluble as an alloying | Ag Zn |
| | | element with zinc | |
| | | | Ag₅ Zn |
| | | soluble as an alloying | Ag Zr |
| | | element with zirconium | |
| | | | Ag Zr₂ |
| | aluminum | soluble as an alloying | Al Au₂ |
| | intermetallics | element with gold | |
| | | | Al₂ Au₅ |
| | | soluble as an alloying | Al B₂ |
| | | element with boron | |
| | | | Al B₁₂ |
| | | soluble as an alloying | Al₄ Ba |
| | | element with barium | |
| | | | Al Ba |
| | | soluble as an alloying | Al₄ Ca |
| | | element with calcium | |
| | | | Al₂ Ca |
| | | soluble as an alloying | Al Co |
| | | element with cobalt | |
| | | | Al₃ Co |
| | | soluble as an alloying | Al₄5 Cr₇ |
| | | element with chromium | |
| | | | Cr₅ Al₈ |
| | | soluble as an alloying | Al₃ Cu |
| | | element with copper | |
| | | | Al₄ Cu₉ |
| | | | Al Cu₂ |
| | | | Al Cu₃ |
| | | | Al Cu |
| | | | Al₂ Cu |
| | | soluble as an alloying | Fe₃ Al |
| | | element with iron | |
| | | | Fe Al₂ |
| | | | Fe₂ Al₅ |
| | | | Fe Al₅ |
| | | soluble as an alloying | Al Li |
| | | element with lithium | |
| | | | Al₂ Li₃ |
| | | | Al₄ Li₉ |
| | | soluble as an alloying | Al₃ Mg₂ |
| | | element with magnesium | |
| | | | Al₁₂ Mg₁₇ |
| | | soluble as an alloying | Al₆ Mn |
| | | element with manganese | |
| | | | Al₁₁ Mn₄ |
| | | soluble as an alloying | Al Mo₃ |
| | | element with | |
| | | molybdenum | |
| | | | Al₈ Mo₃ |
| | | | Al₄ Mo |
| | | | Al₅ Mo |
| | | | Al₁₂ Mo |
| | | soluble as an alloying | Al N |
| | | element with nitrogen | |
| | | soluble as an alloying | Al₃ Nb |
| | | element with niobium | |
| | | | Al Nb₂ |
| | | soluble as an alloying | Al₃ Ni |
| | | element with nickel | |
| | | | Al Ni₃ |
| | | soluble as an alloying | Al₄ Pd |
| | | element with palladium | |
| | | | Al₂1 Pd₈ |
| | | soluble as an alloying | Al₂1 Pt₅ |
| | | element with platinum | |
| | | | Al₃ Pt₅ |
| | | soluble as an alloying | Ti Al₃ |
| | | element with titanium | |
| | | | Ti₃ Al |
| | | soluble as an alloying | Al V₁₀ |
| | | element with vanadium | |
| | | | Al V₃ |
| | | soluble as an alloying | W Al₄ |
| | | element with Tungsten | |
| | | | Al₁₂ W |
| | | soluble as an alloying | |
| | | element with Zinc | |
| | | soluble as an alloying | Al₃ Zr |
| | | element with Zirconium | |
| | | | Al Zr₃ |
| | gold intermetallics | soluble as an alloying | Au₅ Ba |
| | | element with Barium | |
| | | | AU₂ Ba₃ |
| | | soluble as an alloying | Au₃ Be |
| | | element with Beryllium | |
| | | | Au Be₅ |
| | | soluble as an alloying | AU₂ Bi |
| | | element with Bismuth | |
| | | soluble as an alloying | Au Br |
| | | element with Bromine | |
| | | | Au Br₃ |
| | | soluble as an alloying | Au₅ Ca |
| | | element with Calcium | |
| | | | Au Ca₂ |
| | | soluble as an alloying | Au₃ Cr |
| | | element with chrome | |
| | | soluble as an alloying | Au₃ Cu |
| | | element with copper | |
| | | | Au Cu₃ |
| | | soluble as an alloying | Au Ga |
| | | element with gallium | |
| | | | Au Ga₂ |
| | | soluble as an alloying | Au In |
| | | element with indium | |
| | | | Au In₂ |
| | | soluble as an alloying | Au₃ K |
| | | element with potassium | |
| | | | Au K₂ |
| | | soluble as an alloying | AU₆ Li₄ |
| | | element with lithium | |
| | | | Au₄ Li₁₅ |
| | | soluble as an alloying | Mg₃ Au |
| | | element with magnesium | |
| | | | Mg Au₄ |
| | | soluble as an alloying | Au₄ Mn |
| | | element with manganese | |
| | | | Au Mn₂ |
| | | soluble as an alloying | Au₄ N₂ |
| | | element with nitrogen | |
| | | | Au N₃ |
| | | soluble as an alloying | AU₂ Na |
| | | element with sodium | |
| | | | Au Na₂ |
| | | soluble as an alloying | Au₂ P₃ |
| | | element with | |
| | | phosphorous | |
| | | | Au P |
| | | soluble as an alloying | AU₃ Pt |
| | | element with platinum | |
| | | | Au Pt₃ |
| | | soluble as an alloying | Au Sb₂ |
| | | element with antimony | |
| | | soluble as an alloying | Au₁₀ Sn |
| | | element with tin | |
| | | | Au Sn₄ |
| | | soluble as an alloying | Ti₃ Au |
| | | element with titanium | |
| | | | Ti Au₄ |
| | | soluble as an alloying | V Au₂ |
| | | element with vanadium | |
| | | | V Au₄ |
| | | soluble as an alloying | Au₅ Zn₃ |
| | | element with zinc | |
| | | | AU₃ Zn |
| | | soluble as an alloying | AU₄ Zr |
| | | element with zirconium | |
| | | | Au Zr₃ |
| | Cobalt intermetallics | soluble as an alloying | Co₂ Ge |
| | | element with germanium | |
| | | soluble as an alloying | CO₃ In₂ |
| | | element with indium | |
| | | | Co In |
| | | soluble as an alloying | Mg Co₂ |
| | | element with magnesium | |
| | | soluble as an alloying | Mn Co |
| | | element with manganese | |
| | | soluble as an alloying | Co₃ Mo |
| | | element with | |
| | | molybdenum | |
| | | | Co₇ Mo₆ |
| | | soluble as an alloying | Co₃ Nb |
| | | element with niobium | |
| | | | Co₂ Nb |
| | | | Co₇ Nb₆ |
| | | soluble as an alloying | Co₂ P |
| | | element with | |
| | | phosphorous | |
| | | soluble as an alloying | Co S₂ |
| | | element with sulfur | |
| | | | Co₉ S₈ |
| | | soluble as an alloying | Co Sb₂ |
| | | element with antimony | |
| | | | Co Sb₃ |
| | | soluble as an alloying | Co₂ Si |
| | | element with silicon | |
| | | | Co Si₂ |
| | | | Co Si |
| | | soluble as an alloying | Co Sn |
| | | element with tin | |
| | | | Co Sn₂ |
| | | soluble as an alloying | Ti₂ Co |
| | | element with titanium | |
| | | | Ti Co₂ |
| | | | Ti Co |
| | | | Ti Co₃ |
| | | soluble as an alloying | Co₃ V |
| | | element with vanadium | |
| | | | Co V₃ |
| | | soluble as an alloying | Co₃ W |
| | | element with tungsten | |
| | | | Co₇ W₆ |
| | | soluble as an alloying | Co Zn |
| | | element with zinc | |
| | | | Co Zn₁₃ |
| | | soluble as an alloying | Co Zr₃ |
| | | element with zirconium | |
| | | | Co₂3 Zr₆ |
| | Chromium | soluble as an alloying | Cr Fe |
| | intermetallics | element with iron | |
| | | soluble as an alloying | Cr₃ Ge |
| | | element with germanium | |
| | | | Cr₁₁ Ge₁₉ |
| | | soluble as an alloying | Cr₃ Mn₅ |
| | | element with manganese | |
| | | soluble as an alloying | Cr₂ Nb |
| | | element with niobium | |
| | | soluble as an alloying | gamma prime |
| | | element with nickel | |
| | | soluble as an alloying | Cr₃ P |
| | | element with phosphorous | |
| | | | Cr P₃ |
| | | soluble as an alloying | Cr Sb |
| | | element with antimony | |
| | | | Cr Sb₂ |
| | | soluble as an alloying | Cr₃ S₄ |
| | | element with selenium | |
| | | | Cr₂ S₃ |
| | | soluble as an alloying | Cr₃ Si |
| | | element with silicon | |
| | | | Cr₅ Si₃ |
| | | | Cr Si |
| | | | Cr Si₂ |
| | | soluble as an alloying | Ti Cr₂ |
| | | element with titanium | |
| | | soluble as an alloying | Zr Cr₂ |
| | | element with zirconium | |
| | Copper intermetallics | soluble as an alloying | Cu₂ Gd |
| | | element with gadolinium | |
| | | | Cu Gd |
| | | soluble as an alloying | Cu₅ In₈ |
| | | element with indium | |
| | | soluble as an alloying | Mg₂ Cu |
| | | element with magnesium | |
| | | | Mg Cu₂ |
| | | soluble as an alloying | Cu₃ P |
| | | element with | |
| | | phosphorous | |
| | | soluble as an alloying | Cu₂ S |
| | | element with sulfur | |
| | | | Cu S |
| | | soluble as an alloying | Cu Se |
| | | element with selenium | |
| | | | Cu Se₂ |
| | | soluble as an alloying | Cu₂ Si |
| | | element with silicon | |
| | | | Cu₇ Si |
| | | soluble as an alloying | Cu₃ Sn |
| | | element with tin | |
| | | | Cu₆ Sn₅ |
| | | | CU₄ Sn |
| | | | 25 to 40 wt % Sn |
| | | | 21 to 26 wt % Sn |
| | | soluble as an alloying | Ti₂ Cu |
| | | element with titanium | |
| | | | Ti CU₄ |
| | | soluble as an alloying | CU₄ Zr |
| | | element with zirconium | |
| | | | CU₂ Zr |
| | Iron intermetallics | soluble as an alloying | Fe₆ Ga₅ |
| | | element with gallium | |
| | | | Fe Ga₃ |
| | | soluble as an alloying | Fe Ge |
| | | element with germanium | |
| | | | Fe Ge₂ |
| | | soluble as an alloying | Fe₄ N |
| | | element with nitrogen | |
| | | soluble as an alloying | Fe₂ Nb |
| | | element with niobium | |
| | | | Fe Nb |
| | | soluble as an alloying | Fe₃ P |
| | | element with | |
| | | phosphorous | |
| | | soluble as an alloying | Fe Pd |
| | | element with palladium | |
| | | | Fe Pd₃ |
| | | soluble as an alloying | Fe S₂ |
| | | element with sulfur | |
| | | soluble as an alloying | Fe Sb₂ |
| | | element with antimony | |
| | | soluble as an alloying | Fe SC₃ |
| | | element with scandium | |
| | | soluble as an alloying | Fe_{1.04} Se |
| | | element with selenium | |
| | | | Fe Se₂ |
| | | soluble as an alloying | Fe Si |
| | | element with silicon | |
| | | | Fe Si₂ |
| | | | Fe₅ Si₃ |
| | | | Fe₂ Si |
| | | soluble as an alloying | Fe Sn |
| | | element with tin | |
| | | | Fe Sn₂ |
| | | soluble as an alloying | Ti Fe |
| | | element with titanium | |
| | | | Ti Fe₂ |
| | | soluble as an alloying | Fe₂ W |
| | | element with tungsten | |
| | | | Fe W |
| | | soluble as an alloying | Fe₃ Y |
| | | element with Yttrium | |
| | | | Fe₂ Y |
| | | soluble as an alloying | Fe Zn₁₃ |
| | | element with zinc | |
| | | soluble as an alloying | Fe₃ Zr |
| | | element with zirconium | |
| | | | Fe Zr₄ |
| | Magnesium | soluble as an alloying | Mg₂ Ni |
| | intermetallics | element with Nickel | |
| | | | Mg Ni₂ |
| | | soluble as an alloying | Mg₃ Sb₂ |
| | | element with antimony | |
| | | soluble as an alloying | Mg₂ Si |
| | | element with silicon | |
| | | soluble as an alloying | Mg₂ Sn |
| | | element with tin | |
| | | soluble as an alloying | Mg Zn |
| | | element with zinc | |
| | | | Mg Zn₂ |
| | Manganese | soluble as an alloying | Mo₄ Mn₅ |
| | intermetallics | element with | |
| | | molybdenum | |
| | | soluble as an alloying | Mn₄ N |
| | | element with nitrogen | |
| | | soluble as an alloying | Ni Mn₃ |
| | | element with Nickel | |
| | | | Ni₂ Mn |
| | | soluble as an alloying | Mn₃ P |
| | | element with | |
| | | phosphorous | |
| | | | Mn P |
| | | soluble as an alloying | Mn Pt₃ |
| | | element with platinum | |
| | | soluble as an alloying | Mn S |
| | | element with sulfur | |
| | | soluble as an alloying | Mn₂ Sb |
| | | element with antimony | |
| | | soluble as an alloying | Mn₁₁ Si₁₉ |
| | | element with silicon | |
| | | | Mn Si |
| | | soluble as an alloying | Sn₂ Mn |
| | | element with tin | |
| | | | Sn Mn₃ |
| | | soluble as an alloying | Ti Mn |
| | | element with titanium | |
| | | soluble as an alloying | Mn Zn |
| | | element with zinc | |
| | | soluble as an alloying | Mn₂ Zr |
| | | element with zirconium | |
| | Niobium Intermetallics | soluble as an alloying | Ni₆ Nb₇ |
| | | element with nickel | |
| | | | Ni₃ Nb |
| | | | Ni₈ Nb |
| | | soluble as an alloying | Nb Si₂ |
| | | element with silicon | |
| | | | Nb₅ Si₃ |
| | Nickel intermetallics | soluble as an alloying | Ni₃ P |
| | | element with | |
| | | phosphorous | |
| | | | Ni P₃ |
| | | soluble as an alloying | Ni₃ S₂ |
| | | element with sulfur | |
| | | | Ni₃ S₄ |
| | | | Ni S |
| | | | Ni S₂ |
| | | | Ni₇ S₆ |
| | | soluble as an alloying | Ni₃ Sb |
| | | element with antimony | |
| | | soluble as an alloying | Ni Si₂ |
| | | element with silicon | |
| | | | Ni₂ Si |
| | | | Ni Si |
| | | | Ni₃ Si₂ |
| | | | Ni₇ Si₁₈ |
| | | | Ni₆ Si₁₉ |
| | | soluble as an alloying | Ni₃ Sn |
| | | element with tin | |
| | | | Ni₃ Sn₄ |
| | | soluble as an alloying | Ti₂ Ni |
| | | element with titanium | |
| | | | Ti Ni₃ |
| | | soluble as an alloying | Ni₂ V |
| | | element with vanadium | |
| | | | Ni V₃ |
| | | soluble as an alloying | Ni₅ Zr |
| | | element with zirconium | |
| | | | Ni Zr₂ |
| | Platinum intermetallics | soluble as an alloying | Pt₃ Si |
| | | element in silicon | |
| | | | Pt Si |
| | | soluble as an alloying | Pt₃ Sn |
| | | element in tin | |
| | | | Pt Sn₄ |
| | Silicon Intermetallics | soluble as an alloying | V Si₂ |
| | | element with vanadium | |
| | | | V₆ Si₅ |
| | | | V₅ Si₃ |
| | | | V₃ Si |
| | | soluble as an alloying | Si₂ W |
| | | element with tungsten | |
| | | | Si₃ W₅ |
| | Titanium intermetallics | soluble as an alloying | Zn₁₅ Ti |
| | | element in zinc | |
| | | | Zn Ti |
| | Vanadium | soluble as an alloying | V₄ Zn₅ |
| | intermetallics | element in zinc | |
| | | | V Zn₃ |
| | | soluble as an alloying | V₂ Zr |
| | | element in zirconium | |
| | Tungsten intermetallics | soluble as an alloying | W₂ Zr |
| | | element in zirconium | |
| | Zinc intermetallics | soluble as an alloying | Zn₁₄ Zr |
| | | element in zirconium | |
| | | | Zn Zr |
| Polymeric or | poly olefins | poly(propylene) | |
| organic materials, | | | |
| with particles | | | |
| containing | | | |
| | | poly(ethylene) | |
| | poly(methyl | | |
| | methacrylate) | | |
| | poly(vinyl acetate) | | |
| | poly(alpha- | | |
| | methylstyrene) | | |
| | ethylene vinyl acetate | | |
| | polymer | | |
| | poly(maleic anhydride) | | |
| | poly(vinyl pyrrolidone) | | |
| | oligosaccharides | maltodextrin | |
| | disaccharides | cellobiose | |
| | trisaccharides | raffinose | |
| | tetrasaccharides | stachyose | |
| | polysaccharides | chitosan | |
| | | beta-glucan | |
| | | dextrin | |
| | | dextran | |
| | | fructose | |
| | | fructan | |
| | | galactose | |
| | | galactan | |
| | | glucose | |
| | | glucan | |
| | | hemicellulose | |
| | | lignin | |
| | | mannan | |
| | | pectin | |
| | | starch | |
| | | xanthan gum | |
| | | guar gum | |
| | | locust bean gum | |

The illustrative packing modifier materials shown in Table 1 are not necessarily an exhaustive list, and other materials not listed may be considered as a packing modifier (or a component of a packing modifier). In particular, intermetallic compounds other than those listed above may be considered, as the universe of intermetallics that may be considered suitable may be significantly larger than those listed. For instance, a packing modifier may contain any intermetallic that is soluble as an alloying element in an alloy from which the base powder is made.

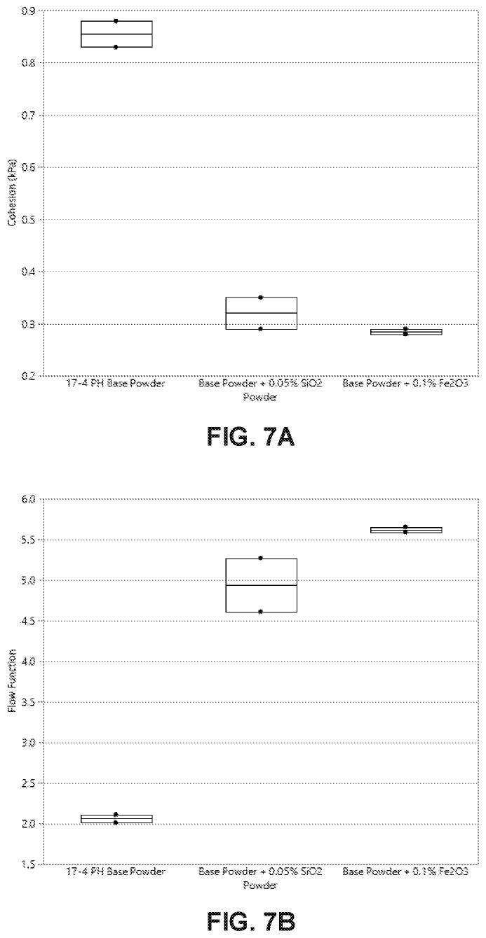

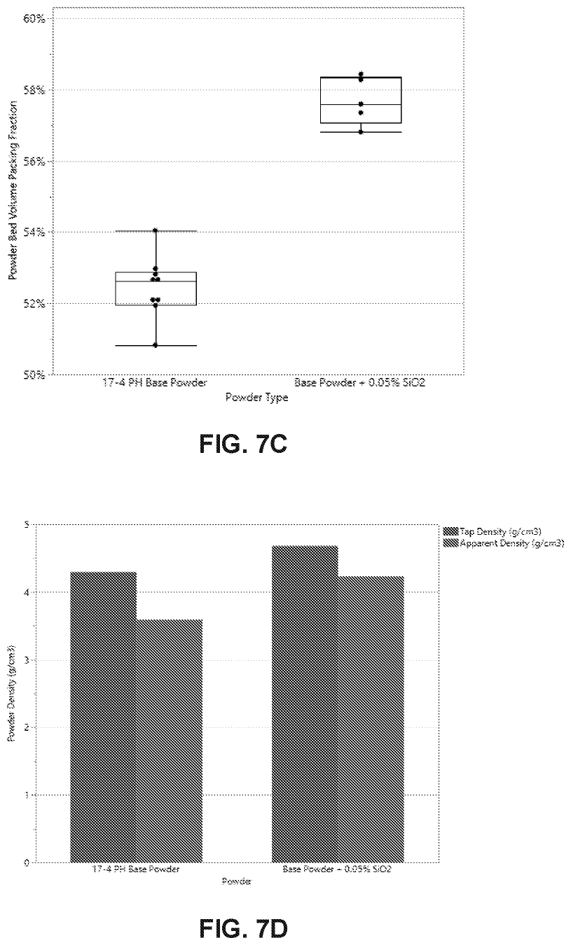

The following examples, illustrated in FIGS. 7A-7D, are intended to illustrate certain embodiments of the present disclosure, but do not exemplify the full scope of the present disclosure.

In one example, the packing behavior of a 17-4 PH stainless steel base powder was controlled through the addition of two different packing modifiers. The 17-4 PH base powder was a standard metal injection molding composition suitable for forming parts from powdered metal, and had a D10 of 6 μm, D50 of 11 μm, and D90 of 19 μm, as measured by a Horiba laser diffraction particle size analyzer using a dry cell (i.e. air dispersed).

The two packing modifiers employed in this example were an SiO₂ powder (0.05 weight percent) from Cabot Corporation (Cab-o-sil L90 fumed silica) with primary particle size of 27 nm and an average agglomerate size of 220-250 nm, and an Fe₂O₃ powder (0.1 weight percent) from Alfa Aesar (iron (III) oxide, alpha-phase, nanopowder, 98%) having an average particle size of 30-50 nm. In each case the powders were mixed by combining the 17-4 PH base powder with the packing modifier powder in a bottle and shaking by hand for approximately five minutes.

The cohesion and flow function were measured according to ASTM standard D6128 using a Freeman FT-4 powder cell rheometer in the shear cell measurement mode. FIGS. 7A and 7B show the measured cohesion and flow function, respectively, for the base powder as well as for each combination of base powder and packing modifier. As shown in the figures, the addition of the packing modifiers resulted in a decrease in the cohesion and an increase in the flow function, corresponding to improved flowability and packing behavior.

Next, the effect of the SiO₂ packing modifier on the powder bed density were characterized. The powder bed density was measured using a bed-to-bed powder deposition system with a counter-rotating roller to spread 100 subsequent 50 μm layers. The total mass of the powder was divided by the volume in the build piston to calculate the powder bed density, and as shown in FIG. 7C, the addition of the packing modifier resulted in an increase in the packing fraction in the powder bed. As further shown in FIG. 7C, addition of the packing modifier also decreases the variation in the measured packing fraction. That is, the variation in the measured packing fraction is decreased upon the addition of the packing modifier as compared to the variation in the measured packing fraction of the base powder.

The tap and apparent densities of the base powder and base powder with SiO₂ packing modifier were also measured using a Micrometrics GeoPyc. As shown in FIG. 7D, the addition of the packing modifier resulted in an increase in both the tap density and apparent density relative to the base powder without the packing modifier.

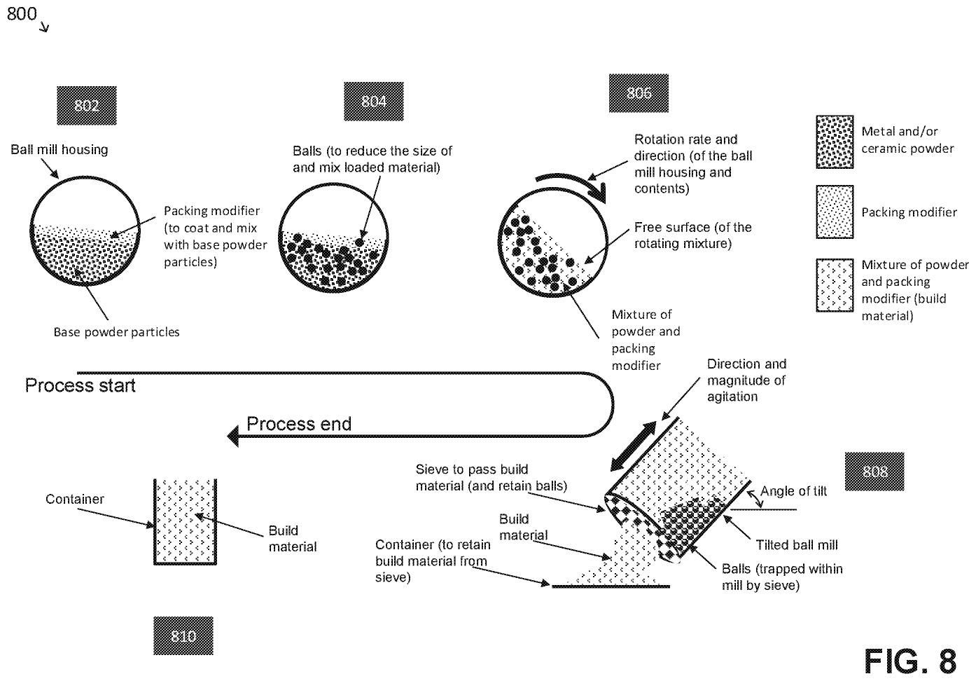

FIG. 8 depicts an illustrative process of mixing a packing modifier with a powder to produce a build material, according to some embodiments. Method 800 begins with act 802 in which a packing modifier is placed within a housing with particles of a base powder with desired relative proportions. In act 804, solid balls are added to the housing to aid in mixing the base powder and packing modifier. In act 806, the housing is rotated to perform said mixing. In act 808, the material is emptied from the housing through a sieve arranged to allow the build material to pass through whilst retaining the balls within the housing. In act 810, a build material within a container is produced and may be subsequently utilized within an additive fabrication process.

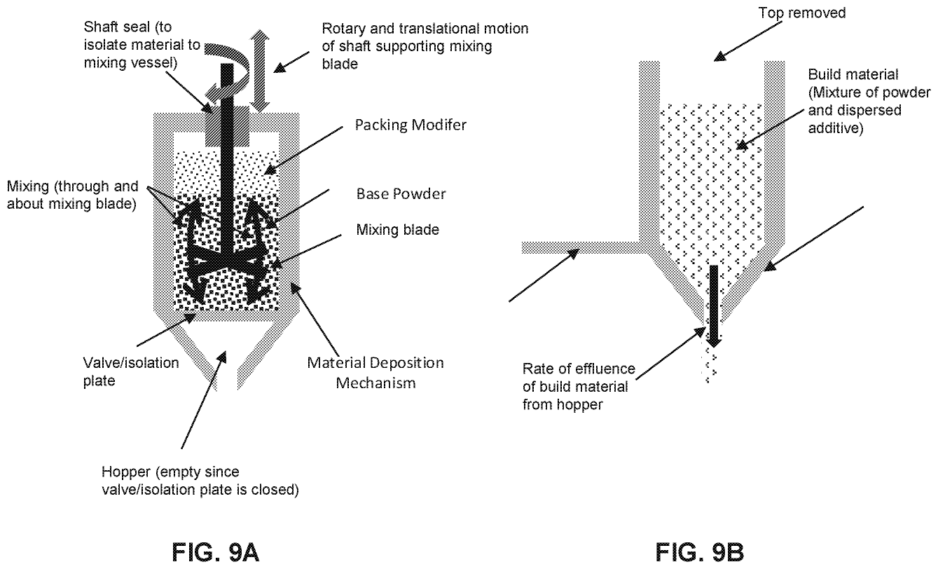

FIGS. 9A-9B depict an illustrative apparatus for mixing a packing modifier with a powder to produce a build material within an additive fabrication device, according to some embodiments. As shown in FIG. 9A, a material deposition mechanism of an additive fabrication apparatus may be arranged to include a mixing chamber connected to, but initially separated from, a hopper. A packing modifier and base powder may be supplied into the mixing chamber and mixed by motion of a mixing blade, which may rotate about an axis and/or translate towards and away from the mixing chamber as shown. Subsequent to mixing the base powder and packing modifier and thereby producing a build material, the top of the material deposition mechanism may be removed (in whole or in part) and the valve separating the mixing chamber from the hopper may be opened, allowing build material powder to flow into the hopper via gravity. The build material may then be dispensed from the hopper during fabrication as described above.

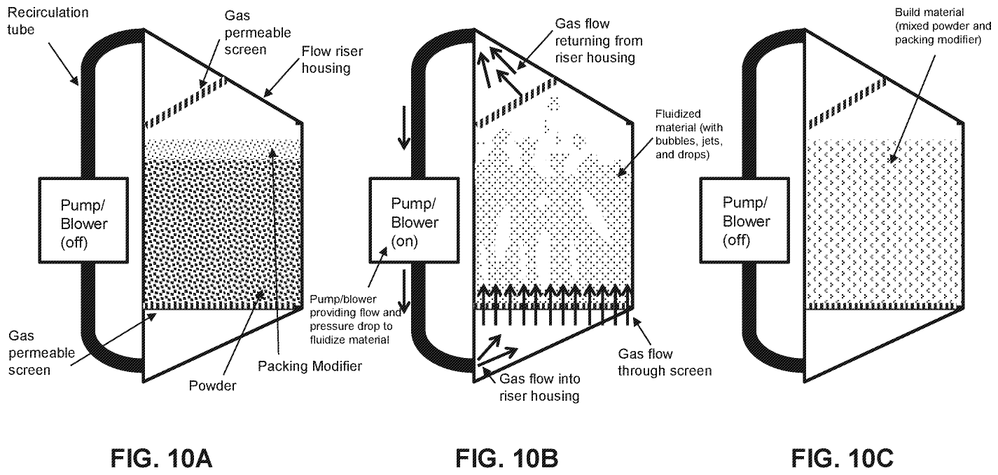

FIGS. 10A-10C illustrate an example of mixing a packing modifier with a powder to produce a build material using an air-driven mixing unit, according to some embodiments. FIG. 10 illustrates a state of the mixing unit subsequent to loading the unit with a base powder and a packing modifier, but prior to initiating operation of the unit. The illustrated unit includes a mixing chamber connected to a pump or blower via a recirculation tube. The powder is contained in the mixing chamber between screens that are permeable to gas, but preferably not to powder so that gas can circulate through the mixing chamber whilst retaining the powder within the mixing chamber. FIG. 10B illustrates a state of the mixing unit after a mixing operation has begun, during which time gas flows through in a loop as described above, agitating and thereby mixing the base powder and packing modifier. FIG. 10C shows the mixing unit after operation has completed and a completed build material is produced in the mixing chamber.

In some embodiments, a mixing unit as shown in FIGS. 10A-10C may be operated without the depicted gas permeable screens, wherein the pump/blower pressure is sufficient to ensure that powder does not fall into the recirculation tube and the dimensions of the mixing chamber are sufficient to prohibit powder from being blown into through the top of the mixing chamber into the recirculation tube. In some embodiments, the pump/blower may comprise a filter suitable for filtering small amounts of powder that is introduced into the recirculation tube and/or the pump/blower may be operate in an environment in which the air includes a quantity of powder.

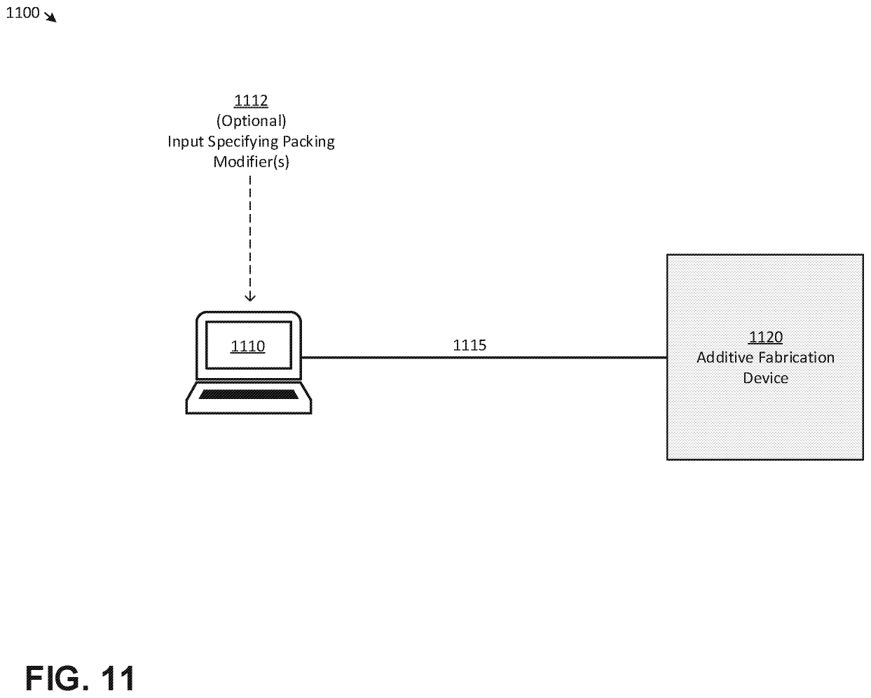

FIG. 11 is a block diagram of a system suitable for practicing aspects of the invention, according to some embodiments. System 1100 illustrates a system suitable for generating instructions to perform additive fabrication by an additive fabrication device and subsequent operation of the additive fabrication device to fabricate a part. For instance, instructions to deposit a build material, to deposit a liquid binder onto a build material, to apply directed energy to a build material, etc. as described by the various techniques above may be generated by the system and provided to the additive fabrication device. Various parameters associated with an additive fabrication process may be stored by computer system 1110 and accessed when generating instructions for the additive fabrication device 1120 to fabricate parts. For example, parameters associated with particular metal powders and/or particular packing modifiers as components of a build material may be accessed by the computer system 1110 to determine a flow rate at which to deposit a build material, a rate at which build material is spread over the build region by a mechanical spreading device, etc. and the instructions generated according to the determined quantities.

According to some embodiments, computer system 1110 may be configured to generate instructions that, when executed by the additive fabrication device 1120, will fabricate a part, wherein said instructions are generated based on a type of packing modifier included within the build material that will be used by the additive fabrication device to fabricate the part. Since the flow and packing behaviors of the build material may be expected to change based on the packing modifier material(s), computer system 1110 may generate the instructions to depend, at least in part, upon an indication of said packing modifier material(s). In some cases, instructions may be generated based on the combination of metal and/or ceramic base powder material(s) and packing modifier material(s), as in some cases the net effect of a packing modifier material may differ depending on the base powder material(s). An indication of such material selections may be supplied in any suitable way to the computer device 1110. One way such material selections may be identified is via optional input 1112, which may include a user-provided input specifying or more types of packing modifiers being included within the build material. Alternatively, or additionally, material selections may be identified automatically by computing device 1110 and/or other components of the system 1100, such as by reading an RFID tag or other scannable identifier of a material source provided to the additive fabrication device 1120.

According to some embodiments, computer system 1110 may be configured to adapt previously generated instructions to fabricate a part based on a type of packing modifier included within the build material that will be used by the additive fabrication device to fabricate the part. For example, one or more parameters defined within the previously generated instructions may be adjusted based on the type of packing modifier included within the build material (e.g., as specified by input 1112). This approach may allow the same generated instructions to be applied to fabricate parts from various different build materials without it being necessary to generate new instructions for each build material. In some cases, instructions may be adapted based on the combination of metal and/or ceramic base powder material(s) and packing modifier material(s).

According to some embodiments, computer system 1110 may execute software that generates two-dimensional layers that may each comprise sections of a part. Instructions may then be generated from this layer data to be provided to an additive fabrication device, such as additive fabrication device 1120, that, when executed by the device, fabricates the layers and thereby fabricates the object. Such instructions may be communicated via link 1115, which may comprise any suitable wired and/or wireless communications connection. In some embodiments, a single housing holds the computing device 1110 and additive fabrication device 1120 such that the link 1115 is an internal link connecting two modules within the housing of system 1100. For instance, computing device 1110 may represent an internal processor of an additive fabrication system with element 1120 representing the remaining components of the system.

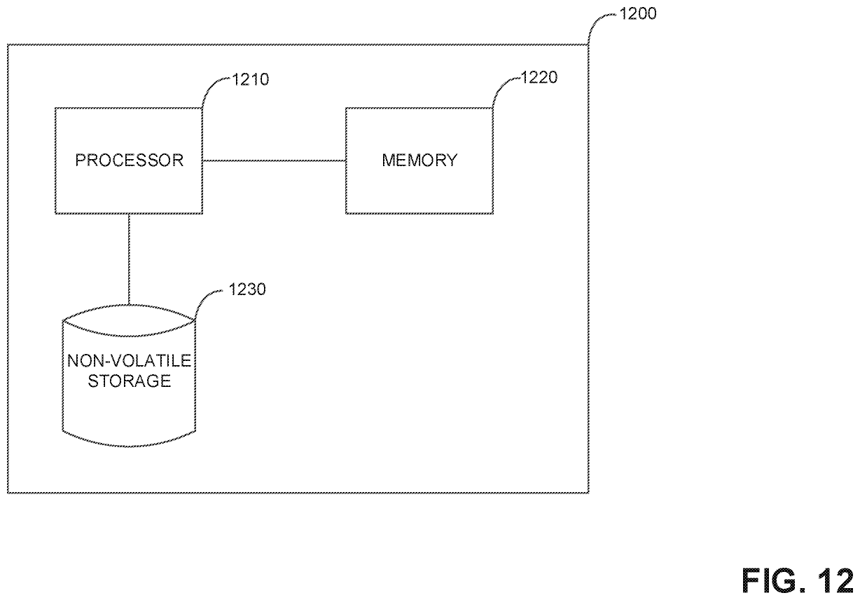

An illustrative implementation of a computer system 1200 that may be used to perform any of the aspects of controller 120 shown in FIG. 1 and/or computer system 1110 shown in FIG. 11, is shown in FIG. 12. The computer system 1200 may include one or more processors 1210 and one or more non-transitory computer-readable storage media (e.g., memory 1220 and one or more non-volatile storage media 1230). The processor 1210 may control writing data to and reading data from the memory 1220 and the non-volatile storage device 1230 in any suitable manner, as the aspects of the invention described herein are not limited in this respect. To perform functionality and/or techniques described herein, the processor 1210 may execute one or more instructions stored in one or more computer-readable storage media (e.g., the memory 1220, storage media, etc.), which may serve as non-transitory computer-readable storage media storing instructions for execution by the processor 1210.

In connection with techniques described herein, code used to, for example, generate instructions that, when executed, cause an additive fabrication device to fabricate a part, control one or more print heads to deposit a liquid onto a powder bed, control one or more energy sources to direct energy onto a build material, move a roller to distribute build material, automatically mix build material, etc. may be stored on one or more computer-readable storage media of computer system 1200. Processor 1210 may execute any such code to provide any techniques for fabricating parts from a build material as described herein. Any other software, programs or instructions described herein may also be stored and executed by computer system 1200. It will be appreciated that computer code may be applied to any aspects of methods and techniques described herein. For example, computer code may be applied to interact with an operating system to transmit instructions to an additive fabrication device through conventional operating system processes.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

According to some aspects, a non-transitory computer readable medium may be provided comprising instructions that, when executed by a processor, perform a method of adapting additive fabrication of an object based on components of a build material from which the object is to be fabricated, the method comprising receiving an indication that a packing modifier is included within the build material for an additive fabrication device, the additive fabrication device configured to fabricate solid objects by selectively joining portions of the build material, and generating, based on the received indication, instructions that, when executed by the additive fabrication device, cause the additive fabrication device to fabricate the object, wherein the instructions are configured to control one or more of the following based on the choice of packing modifier: a rate at which build material is deposited into a build region, and a rate at which build material is spread over the build region by a mechanical spreading device.

According to some embodiments, the instructions cause the additive fabrication device to join the build material via a binder jetting process.

According to some embodiments, the instructions cause the additive fabrication device to join the build material via selective laser melting or direct laser metal sintering.

According to some embodiments, the instructions are further configured to control an amount of liquid evaporated and applied to the build material as a vapor based on the choice of packing modifier.

According to some embodiments, the instructions are further configured to control a selection of a binder liquid from amongst a number of choices based on the choice of packing modifier.

According to some embodiments, the instructions are further configured to control a droplet size of a binder liquid deposited onto the build material based on the choice of packing modifier.

According to some embodiments, the instructions are generated by slicing a model of the object and generating instructions to fabricate layers of the object whilst adapting selected process parameters

According to some embodiments, the instructions are generated by applying a scaling factor to one or more previously prepared instructions, where the scaling factor is selected based on the choice of packing modifier.

According to some embodiments, the indication of the packing modifier is received via a user interface

According to some embodiments, the indication of the packing modifier identifies a packing modifier containing one or more metal oxides, metal carbides, metal silicides, metal nitrides and/or intermetallic compounds.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments described herein.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively.

The terms “substantially,” “approximately” and “about” may be used to mean within ±20% of a target value in some embodiments, within ±10% of a target value in some embodiments, within ±5% of a target value in some embodiments, and yet within ±2% of a target value in some embodiments. The terms “substantially,” “approximately” and “about” may include the target value.

What is claimed is:

1. A method of fabricating a metal and/or ceramic part through additive manufacturing, the method comprising:
depositing a layer of a build material over a build surface, wherein the build material comprises a base powder mixed with one or more packing modifiers,
wherein the base powder comprises a metallic powder and/or a ceramic powder, and
wherein the packing modifier comprises one or more metal oxides, metal carbides, metal silicides, metal nitrides, and/or intermetallic compounds;
selectively joining one or more regions of the build material within the deposited layer by depositing a liquid onto the one or more regions;
repeating said acts of depositing and selectively joining for a plurality of layers of the build material to form a first part; and
forming a metal and/or ceramic part by thermally processing the first part.

2. The method of claim 1, wherein thermally processing the first part comprises sintering the first part in a furnace.

3. The method of claim 1, wherein thermally processing the first part comprises infiltrating the first part with a molten metallic material.

4. The method of claim 1, wherein thermally processing the first part comprises removing the liquid and the one or more packing modifiers from the first part.

5. The method of claim 1, wherein the packing modifier comprises one or more metal oxides.

6. The method of claim 5, wherein the one or more metal oxides includes an iron oxide, a nickel oxide, a copper oxide, a chromium oxide, a vanadium oxide, a molybdenum oxide, a bismuth oxide, a cobalt oxide, a tin oxide, and/or a lead oxide.

7. The method of claim 1, wherein the packing modifier comprises one or more non-metal carbides.

8. The method of claim 1, wherein the packing modifier comprises at least one of a material comprising aluminum and chlorine, carbide, silicon nitride, an anhydrous metal nitrate, and a metal silicide.

9. The method of claim 1, wherein the packing modifier and the base powder comprise a common metallic element.

10. The method of claim 1, wherein a weight percent of the packing modifier in the build material is between 0.01% and 10%.

11. The method of claim 1, wherein the base powder has a mean particle size between 5 μm and 25 μm, and the packing modifier has a mean particle size between 20 nm and 10 μm.

12. The method of claim 1, wherein a ratio of a mean particle size of the base powder to a mean particle size of the packing modifier is between 50 and 1000.

13. The method of claim 1, wherein the packing modifier coats particles of the base powder.

14. A method of fabricating a metal and/or ceramic part through additive manufacturing, the method comprising:
depositing a layer of a build material over a build surface, wherein the build material comprises a base powder mixed with one or more packing modifiers,
wherein the base powder comprises a metallic powder and/or a ceramic powder, and
wherein the packing modifier comprises one or more metal oxides, carbides, silicides, nitrides, hydrides, and/or intermetallic compounds;
selectively joining one or more regions of the build material within the deposited layer by depositing a liquid onto the one or more regions; and
repeating said acts of depositing and selectively joining for a plurality of layers of the build material to form a first part.

15. The method of claim 14, wherein the packing modifier comprises one or more metal oxides.

16. The method of claim 15, wherein the one or more metal oxides includes an iron oxide, a nickel oxide, a copper oxide, a chromium oxide, a vanadium oxide, a molybdenum oxide, a bismuth oxide, a cobalt oxide, a tin oxide, and/or a lead oxide.

17. The method of claim 14, wherein the packing modifier comprises one or more non-metal carbides.

18. The method of claim 14, wherein the packing modifier comprises at least one of a material comprising aluminum and chloride, silicon carbide, silicon nitride, an anhydrous metal nitrate, and a metal silicide.

19. The method of claim 14, wherein the packing modifier and the base powder comprise a common metallic element.

20. The method of claim 14, wherein a weight percent of the packing modifier in the build material is between 0.01% and 10%.

21. The method of claim 14, wherein the base powder has a mean particle size between 5 μm and 25 μm, and the packing modifier has a mean particle size between 20 nm and 10 μm.

22. The method of claim 14, wherein a ratio of a mean particle size of the base powder to a mean particle size of the packing modifier is between 50 and 1000.

23. The method of claim 14, wherein the packing modifier coats particles of the base powder.

24. A method of fabricating a metal and/or ceramic part through additive manufacturing, the method comprising:
depositing a layer of a build material over a build surface, wherein the build material comprises a base powder mixed with one or more packing modifiers,
wherein the base powder comprises a metallic powder and/or a ceramic powder, and
wherein the packing modifier comprises one or more metal oxides, carbides, silicides, nitrides, hydrides, and/or intermetallic compounds;
selectively joining one or more regions of the build material within the deposited layer; and
repeating said acts of depositing and selectively joining for a plurality of layers of the build material to form a first part.

25. The method of claim 24, wherein the packing modifier comprises one or more metal oxides.

26. The method of claim 25, wherein the one or more metal oxides includes an iron oxide, a nickel oxide, a copper oxide, a chromium oxide, a vanadium oxide, a molybdenum oxide, a bismuth oxide, a cobalt oxide, a tin oxide, and/or a lead oxide.

27. The method of claim 24, wherein the packing modifier comprises one or more non-metal carbides.

28. The method of claim 24, wherein the packing modifier comprises at least one of a material comprising aluminum and chloride, silicon carbide, silicon nitride, an anhydrous metal nitrate, and a metal silicide.

29. The method of claim 24, wherein the packing modifier and the base powder comprise a common metallic element.

30. The method of claim 24, wherein a weight percent of the packing modifier in the build material is between 0.01% and 10%.

31. The method of claim 24, wherein the base powder has a mean particle size between 5 μm and 25 μm, and the packing modifier has a mean particle size between 20 nm and 10 μm.

32. The method of claim 24, wherein a ratio of a mean particle size of the base powder to a mean particle size of the packing modifier is between 50 and 1000.

33. The method of claim 24, wherein the packing modifier coats particles of the base powder.
